(19) United States
(12) Patent Application Publication
(10) Pub. No.: US 2009/0064596 A1
(43) Pub. Date: Mar. 12, 2009

(54) Opening-and-closing device and robot device

(75) Inventors: Wataru Kokubo, Tokyo (JP); Kenichi Hirano, Saitama (JP); Toshihiro Kusunoki, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/231,668

(22) Filed: Sep. 4, 2008

(30) Foreign Application Priority Data
Sep. 6, 2007 (JP) JP2007-232011

(51) Int. Cl. E06B 5/00

(52) U.S. Cl. 49/507; 901/50

(57) ABSTRACT

When the opening-and-closing unit is pushed toward the base unit as if making them close such that the facing surfaces of the rotational body pinching units cover the outer surfaces of the rotational body to attach the opening-and-closing unit to the rotational body, the shaft end sections and the angle reference sections fit in the shaft supporting sections and the angle adjustment sections respectively, and thereby hold the rotational body so as to align the rotational range with the opening-and-closing range.

### CROSS REFERENCES TO RELATED APPLICATIONS

The present invention contains subject matter related to Japanese Patent Application JP2007-232011 filed in the Japanese Patent Office on Sep. 6, 2007, the entire contents of which being incorporated herein by reference.

### BACKGROUND OF THE INVENTION

1. Field of the Invention

The present invention relates to an opening-and-closing device and robot device, and is preferably applied to an audio robot device that can reproduce music data, for example.

2. Description of the Related Art

A typical rotational device mounted on a mobile phone extends from the mobile phone's upper-side housing to lower-side housing. The rotational device has a rotational body near one edge of one surface of the lower-side housing.

To one edge of the rotational body, one end of an opening-and-closing hinge unit is firmly attached. By another end of the opening-and-closing hinge unit, one end of an opening-and-closing shaft is held up such that the upper-side housing can rotate around the opening-and-closing shaft with respect to the lower-side housing: the upper-side housing rotates in a closing direction, a direction in which the upper-side housing moves toward the lower-side housing, and in an opening direction, a direction in which the upper-side housing moves away from the lower-side housing.

The opening-and-closing hinge unit limits the degree of rotation of the opening-and-closing shaft which rotates in the closing and opening directions.

By another edge of the rotational body, one end of a guide shaft is held up such that the guide shaft is aligned with the opening-and-closing shaft on the same axial line, and that the guide shaft can be rotated. In the rotational device, another end of the opening-and-closing shaft and another end of the guide shaft are firmly attached to the upper-side housing.

In that manner, the rotational device allows the upper-side housing to rotate with respect to the lower-side housing by rotating both the opening-and-closing shaft and the guide shaft, as disclosed in Jpn. Pat. Laid-open Publication No. 2005-121068, pages 8 and 9, and FIGS. 1, 3 and 4.

### SUMMARY OF THE INVENTION

By the way, as mentioned above, the opening-and-closing hinge unit of the rotational device restricts the degree of rotation of the opening-and-closing shaft to a rotation angle range which is from 0 degree, at which the upper-side and lower-side housings are completely closed together, to 180 degrees, at which the upper-side housing is fully separated from the lower-side housing.

Accordingly, in the rotational device, when the upper-side housing is attached to the opening-and-closing shaft, for example, the range of rotation of the opening-and-closing shaft is restricted to the rotation angle range.

After that, the range of rotation of the upper-side housing with respect to the lower-side housing is adjusted to the range of rotation of the opening-and-closing shaft, or the range of 0 to 180 degrees. In this manner, the upper-side housing is attached to the opening-and-closing shaft.

Accordingly, in the rotational device, when the opening-and-closing shaft rotates to the limit of its travel in the closing direction, or 0 degree, the upper-side and lower-side housings are closed together. When the opening-and-closing shaft rotates to the limit of its travel in the opening direction, or 180 degrees, the upper-side housing is completely separated from the lower-side housing.

However, if the upper-side housing has not been attached to the opening-and-closing shaft appropriately, the range of rotation of the opening-and-closing shaft may differ from that of the upper-side housing with respect to the lower-side housing. In this case, the upper-side and lower-side housings may not be fully closed, leaving the opening between them.

The same could be said of opening the housings: the upper-side housing may not be fully separated from the lower-side housing, leaving the angle of the upper-side housing with respect to the lower-side housing less than 180 degrees.

To avoid this, the range of rotation of the opening-and-closing shaft may need to be checked after it is attached to the upper-side housing. If not appropriate, the range of rotation of the opening-and-closing shaft may need to be adjusted to the appropriate range.

Therefore, it is not easy to attach the upper-side housing to the opening-and-closing shaft.

The present invention has been made in view of the above points and is intended to provide an opening-and-closing device and robot device that allows an opening-and-closing unit to be easily attached to a rotational body.

In one aspect of the invention, an opening-and-closing device, whose opening-and-closing unit can open and close with respect to a base unit, includes: a rotational body with two outer surfaces facing outwardly and oppositely of the opposite surface, both of which are equipped with shaft end sections that are the equivalent of the one and other ends of a rotational shaft at the ends of which the outer surfaces are provided, and at least one of which is equipped with an angle reference section that aligns the rotational range around the rotational shaft with the opening-and-closing range of an opening-and-closing unit with respect to the base unit; a rotational body holding unit provided on the base unit, the rotational body holding unit holding the rotational body such that the opening-and-closing unit can rotate around the rotational shaft in closing and opening directions to be closed and opened with respect to the base unit within a predetermined rotational angle range; and a pair of rotational body pinching units with facing surfaces by which the outer surfaces of the rotational body are covered and held, the facing surfaces being equipped with shaft supporting sections corresponding to the shaft end sections and angle adjustment sections in which the angle reference sections fit to align the rotational range with the opening-and-closing range, wherein when the opening-and-closing unit is pushed toward the base unit as if making them close such that the facing surfaces of the rotational body pinching units cover the outer surfaces of the rotational body to attach the opening-and-closing unit to the rotational body, the shaft end sections and the angle reference sections fit in the shaft supporting sections and the angle adjustment sections respectively, and thereby hold the rotational body so as to align the rotational range with the opening-and-closing range.

Accordingly, without checking and adjusting the rotational range of the rotational body, a user can attach the opening-and-closing unit to the rotational body so as to align the rotational range of the rotational body with the opening-and-closing range of the opening-and-closing unit with respect to the base unit.

As mentioned above, an opening-and-closing device, whose opening-and-closing unit can open and close with respect to a base unit, includes: a rotational body with two outer surfaces facing outwardly and oppositely of the opposite surface, both of which are equipped with shaft end sections that are the equivalent of the one and other ends of a rotational shaft at the ends of which the outer surfaces are provided, and at least one of which is equipped with an angle reference section that aligns the rotational range around the rotational shaft with the opening-and-closing range of an opening-and-closing unit with respect to the base unit; a rotational body holding unit provided on the base unit, the rotational body holding unit holding the rotational body such that the opening-and-closing unit can rotate around the rotational shaft in closing and opening directions to be closed and opened with respect to the base unit within a predetermined rotational angle range; and a pair of rotational body pinching units with facing surfaces by which the outer surfaces of the rotational body are covered and held, the facing surfaces being equipped with shaft supporting sections corresponding to the shaft end sections and angle adjustment sections in which the angle reference sections fit to align the rotational range with the opening-and-closing range, wherein when the opening-and-closing unit is pushed toward the base unit as if making them close such that the facing surfaces of the rotational body pinching units cover the outer surfaces of the rotational body to attach the opening-and-closing unit to the rotational body, the shaft end sections and the angle reference sections fit in the shaft supporting sections and the angle adjustment sections respectively, and thereby hold the rotational body so as to align the rotational range with the opening-and-closing range. Accordingly, without checking and adjusting the rotational range of the rotational body, a user can attach the opening-and-closing unit to the rotational body so as to align the rotational range of the rotational body with the opening-and-closing range of the opening-and-closing unit with respect to the base unit. Thus, the opening-and-closing unit can be easily attached to the base unit.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a schematic perspective view of an audio robot device according to an embodiment of the present invention;

FIG. 2 is a schematic diagram illustrating the configuration of the back of the audio robot device;

FIG. 3 is a schematic diagram illustrating how right and left opening-and-closing units open and close with respect to right and left rotational units;

FIG. 4 is a schematic diagram illustrating the rotation of right and left rotational units;

FIG. 5 is a schematic diagram illustrating the configuration of opening-and-closing mechanical units;

FIG. 6 is a schematic diagram illustrating the configuration of a rotational body;

FIG. 7 is a schematic diagram illustrating the configuration of rotation conveying units;

FIG. 8 is a side view of a rotation conveying unit to illustrate how the rotation conveying unit rotates in a closing direction;

FIG. 9 is a side view of a rotation conveying unit to illustrate how the rotation conveying unit rotates in an opening direction;

FIG. 10 is a side view of a rotation conveying unit to illustrate how the rotation conveying unit rotates in a closing direction;

FIG. 11 is a side view of a rotation conveying unit to illustrate how the rotation conveying unit rotates in an opening direction;

FIG. 12 is a schematic diagram illustrating the configuration of right and left opening-and-closing units and a opening-and-closing-side mechanical unit;

FIG. 13 is a schematic diagram illustrating the configuration of a rotational body pinching unit;

FIG. 14 is a schematic diagram illustrating the configuration of a rotational body pinching unit;

FIG. 15 is a schematic diagram illustrating how elastic a rotational body pinching unit is;

FIG. 16 is a schematic diagram illustrating how right and left opening-and-closing units are attached to a rotational body (1);

FIG. 17 is a schematic diagram illustrating the opening and closing of right and left opening-and-closing units in accordance with the rotation of a rotational body (1);

FIG. 18 is a schematic diagram illustrating the opening and closing of right and left opening-and-closing units in accordance with the rotation of a rotational body (2);

FIG. 19 is a schematic diagram illustrating how right and left opening-and-closing units are attached to a rotational body (2);

FIG. 20 is a schematic diagram illustrating rotational body pinching units holding a rotational body when a pinching section direction is aligned with a rotational body direction;

FIG. 21 is a schematic diagram illustrating rotational body pinching units holding a rotational body when a pinching section direction is not aligned with a rotational body direction (1);

FIG. 22 is a schematic diagram illustrating rotational body pinching units holding a rotational body when a pinching section direction is not aligned with a rotational body direction (2);

FIG. 23 is a schematic diagram illustrating rotational body pinching units holding a rotational body when a pinching section direction intersects with a rotational body direction (1);

FIG. 24 is a schematic diagram illustrating rotational body pinching units holding a rotational body when a pinching section direction intersects with a rotational body direction (2);

FIG. 25 is a schematic diagram illustrating rotational body pinching units holding a rotational body when a pinching section direction intersects with a rotational body direction (3);

FIG. 26 is a schematic diagram illustrating rotational body pinching units holding a rotational body when a pinching section direction intersects with a rotational body direction (4);

FIG. 27 is a schematic diagram illustrating a rotation conveying unit stopped by an opening angle limitation section;

FIG. 28 is a schematic diagram illustrating a rotation conveying unit stopped by an opening angle limitation section;

FIG. 29 is a schematic diagram illustrating how shaft end sections and angle reference units fit in shaft supporting sections and angle adjustment sections;

FIG. 30 is a schematic diagram illustrating how to detach right and left opening-and-closing units from a rotational body; and

FIG. 31 is a block diagram illustrating the circuit configuration of an audio robot device.

### DETAILED DESCRIPTION OF PREFERRED EMBODIMENTS

An embodiment of the present invention will be described in detail with reference to the accompanying drawings.

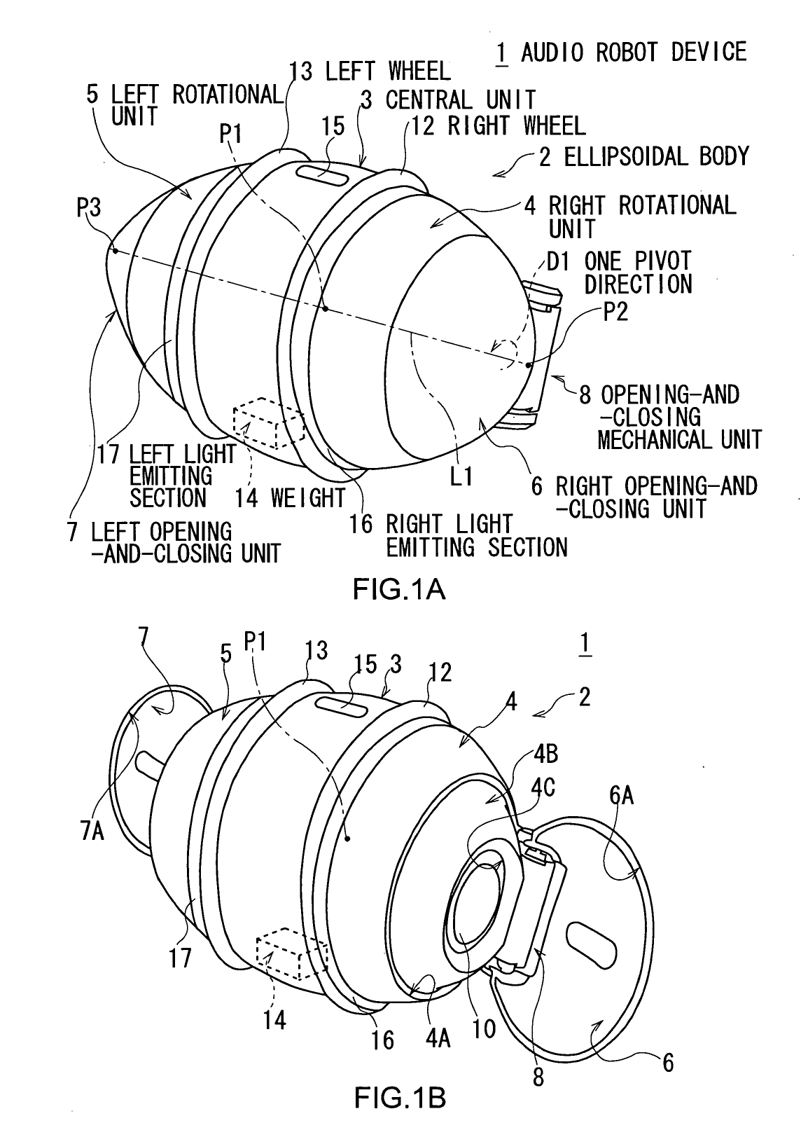

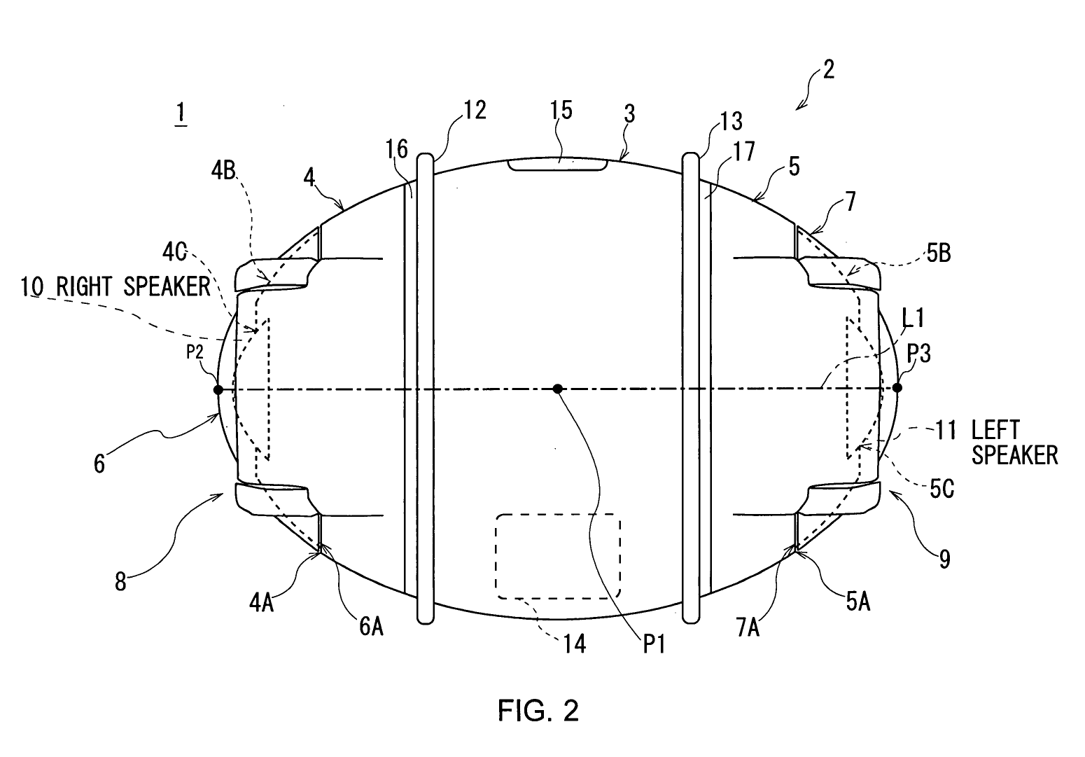

In FIGS. 1A, 1B and 2, the reference numeral 1 denotes an audio robot device as a whole, according to an embodiment of the present invention.

The audio robot device 1 includes a substantially ellipsoidal body 2 as a whole, for example.

The ellipsoidal body 2 includes a substantially barrel-shaped central unit 3, the right end of which is attached to a first rotational unit (also referred to as “right rotational unit”) 4 which is substantially conical with its head part cut off.

The left end of the central unit 3 is attached to a second rotational unit (also referred to as “left rotational unit”) 5 which is substantially formed conical with its head part cut off.

The right side of the right rotational unit 4 is attached to a first opening-and-closing unit (also referred to as “right opening-and-closing unit) 6 which is substantially dome-shaped.

The left side of the left rotational unit 5 is attached to a second opening-and-closing unit (also referred to as “left opening-and-closing unit) 7 which is substantially dome-shaped.

By the way, an imaginary line segment joining the right and left points P2 and P3 is also referred to as horizontal rotational shaft line L1: P2 and P3 are the farthest points on the surface of the ellipsoidal body 2 from the center P1 of the ellipsoidal body 2.

The right rotational section 4 is held by a shaft so that it can rotate 320 degrees around the horizontal rotational shaft line L1 with respect to the central unit 3 in one pivot direction D1 or the other pivot direction.

The left rotational section 5 is held by a shaft so that it can rotate 320 degrees around the horizontal rotational shaft line L1 with respect to the central unit 3 in one pivot direction D1 or the other pivot direction.

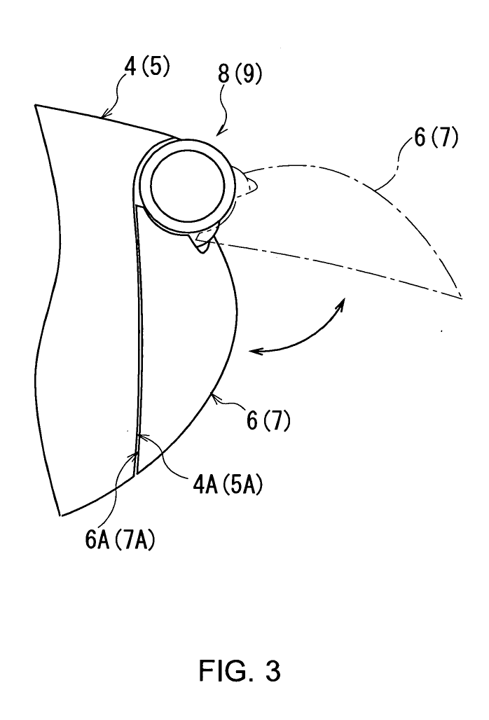

As shown in FIG. 3, the right opening-and-closing unit 6 is attached to the right rotational unit 4 via an opening-and-closing mechanical unit 8 that allows the right opening-and-closing unit 6 to rotate within a predetermined range (also referred to as “opening-and-closing range”).

In this case, the opening-and-closing range is from 0 degree, at which the right-side edge 4A of the right rotational section 4 touches the left-side edge 6A of the right opening-and-closing unit 6, to approximately 80 degrees.

The right opening-and-closing unit 6 is driven by a motor (not shown) housed in the opening-and-closing mechanical unit 8, and is therefore opened and closed.

The left opening-and-closing unit 7 is attached to the left rotational unit 5 via an opening-and-closing mechanical unit 9 that allows the left opening-and-closing unit 7 to rotate within a predetermined range (also referred to as “opening-and-closing range”).

In this case, the opening-and-closing range is from 0 degree, at which the left-side surface 5A of the left rotational section 5 touches the left-side surface 7A of the left opening-and-closing unit 7, to approximately 80 degrees.

The left opening-and-closing unit 7 is driven by a motor (not shown) housed in the opening-and-closing mechanical unit 9, and is therefore opened and closed. The left opening-and-closing unit 7 and the right opening-and-closing unit 6 are driven separately.

The right-side surface unit 4B of the right rotational section 4 protrudes like a mountain, at the summit of which a hole section 4C is formed like a pipe.

The device 1 has a pair of stereo speakers 10 and 11 with the same shape. A right speaker (a first speaker) 10 is housed in the right rotational section 4, and a part of the right speaker, or the front of a dome-shaped diaphragm, extends outside the hole section 4C.

When the right opening-and-closing unit 6 is closed by the opening-and-closing mechanical unit 8, the left-side edge 6A touches the right-side edge 4A of the right rotational unit 4, and consequently covers the diaphragm of the right speaker 10.

When the right opening-and-closing unit 6 is opened by the opening-and-closing mechanical unit 8, the left-side edge 6A is separated from the right-side edge 4A of the right rotational unit 4, and consequently exposes the diaphragm of the right speaker 10.

The left-side surface 5B of the left rotational section 5 protrudes like a mountain, at the summit of which a hole section SC is formed like a pipe.

A left speaker (a second speaker) 11 is housed in the left rotational section 5, and a part of the left speaker, or the front of a dome-shaped diaphragm, extends outside the hole section SC.

When the left opening-and-closing unit 7 is closed by the opening-and-closing mechanical unit 9, the right-side edge 7A touches the left-side edge 5A of the right rotational unit 5, and consequently covers the diaphragm of the left speaker 11.

When the left opening-and-closing unit 7 is opened by the opening-and-closing mechanical unit 9, the right-side edge 7A is separated from the left-side edge 5A of the right rotational unit 5, and consequently exposes the diaphragm of the left speaker 11.

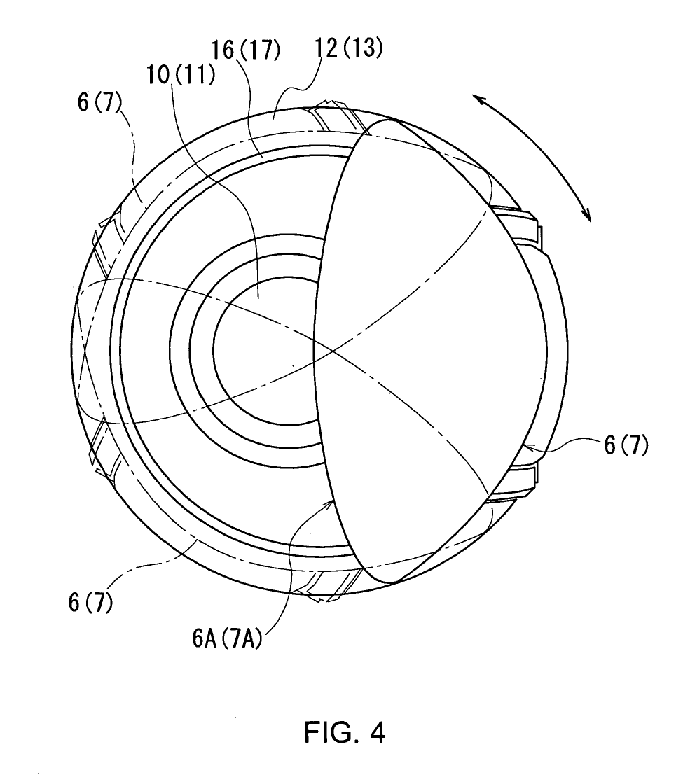

As shown in FIG. 4, the right rotational unit 4 rotates separately from the left rotational unit 5.

The right rotational unit 4 also works separately from the right opening-and-closing unit 6, which is opened and closed. Moreover, the left rotational unit 5 works separately from the left opening-and-closing unit 7.

Furthermore, as shown in FIGS. 1A, 1B and 2, a ring-shaped right wheel 12 is provided around the right edge of the central unit 3; the right wheel 12 is held by a shaft so that it can rotate around the horizontal rotational shaft line L1 in the one pivot direction D1 or the other pivot direction.

Furthermore, a left wheel 13 that is formed in the same shape as the right wheel 12 is provided around the left edge of the central unit 3; the left wheel 13 is held by a shaft so that it can rotate around the horizontal rotational shaft line L1 in the one pivot direction D1 or the other pivot direction.

In this case, the outer diameter of the right and left wheels is larger than that of the central unit 3.

This allows the right and left wheels 12 and 13, which can rotate, to carry the ellipsoidal body 2 on a table.

The right and left wheels 12 and 13 can be controlled separately. By driving the right and left wheels 12 and 13 at different speeds or in different directions, the ellipsoidal body 2 moves in various manners, including circling around.

Moreover, a weight 14 is situated at a predetermined position inside the central unit 3: the weight 14, such as a battery, is firmly attached to the inner wall of the unit 3.

As for the central unit 3, the distance from the center point P1 to the right edge (or the right wheel 12) is substantially equal to the distance from the center point P1 to the left edge (or the left wheel 12).

The right rotational unit 4 and the left rotational unit 5 are formed in the same shape and size.

The right opening-and-closing unit 6 and the left opening-and-closing unit 7 are formed in the same shape and size: the distance from left-side edge 6A to the surface's summit P2 is substantially equal to the distance from right-side edge 7A to the surface's summit P3.

Therefore, the ellipsoidal body 2 is symmetrical about an imaginary plane (not shown) drawn in such a way that it passes through the center point P1 and is perpendicular to the horizontal rotational shaft line L1.

Accordingly, when the ellipsoidal body 2 is put on a table or floor, the central unit 3 does not touch the table or floor, being a little above the table top: the ellipsoidal body 2 is kept by the right and left wheels 12 and 13 with the horizontal rotational shaft line L1 parallel to the table's surface.

By the way, hereinafter, assume that the ellipsoidal body 2 will be put on a floor.

Thanks to the weight 14 situated inside the central unit 3, the center of gravity of the central unit 3 is closer to the inner wall than to the center point P1.

When the ellipsoidal body 2 is put on the floor, it takes a basic position in which case the weight 14 is positioned at the bottom.

Since the weight 14 is appropriately selected, the ellipsoidal body 2 on the floor maintains the basic position without swaying to the left or right, even when the right opening-and-closing unit 6 and the left opening-and-closing unit 7 are working separately.

The ellipsoidal body 2 on the floor maintains the basic position without swaying to the left or right, even when the right rotational unit 4 and the left rotational unit 5, and the right opening-and-closing unit 6 and the left opening-and-closing unit 7 are working separately.

As mentioned above, thanks to the weight 14, the center of gravity of the central unit 3 is closer to the inner wall than to the center point P1.

This prevents the rotation of the central unit 3 even when the ellipsoidal body 2 is running on the floor.

Thanks to the relatively heavy weight 14, the ellipsoidal body 2 running on the floor can maintain the basic position without swaying to the left or right, even when the right opening-and-closing unit 6 and the left opening-and-closing unit 7 are working separately.

In addition, the ellipsoidal body 2 running on the floor can maintain the basic position without swaying to the left or right, even when the right rotational unit 4 and the left rotational unit 5, and the right opening-and-closing unit 6 and the left opening-and-closing unit 7 are working separately.

On the surface of the central unit 3, a touch detection sensor 15 is provided: the touch detection sensor 15 is placed at the opposite side to the weight 14. The touch detection sensor 15 detects a finger or hand put thereon.

On the right side of the right wheel 12, a ring-shaped right light emitting unit 16 is provided: the light emitting unit 16 emits light. On the left side of the left wheel 13, a ring-shaped left light emitting unit 17 is provided: the left light emitting unit 17 has the same configuration as the unit 16.

The right light emitting unit 16 and left light emitting unit 17 are illuminated in various ways: only the part, or sometimes the entire part, may be illuminated in different colors.

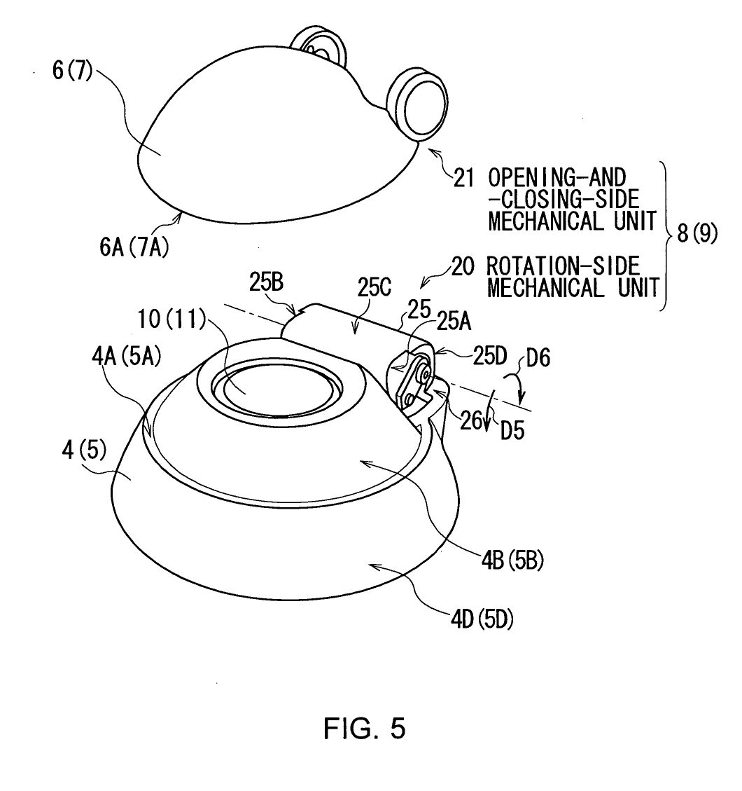

As shown in FIG. 5, the opening-and-closing mechanical unit 8 of the audio robot device 1 includes a rotation-side mechanical unit 20 and an opening-and-closing-side mechanical unit 21: the rotation-side mechanical unit 20 is situated inside the right rotational unit 4; the opening-and-closing-side mechanical unit 21 is situated inside the right opening-and-closing unit 6.

The opening-and-closing mechanical unit 9 has the same configuration as the unit 8: the rotation-side mechanical unit 20 is situated inside the left rotational unit 5; the opening-and-closing-side mechanical unit 21 is situated inside the left opening-and-closing unit 7.

The rotation-side mechanical unit 20 has a rotational unit holding section 25, which is shaped like a box. The rotational unit holding section 25 is attached to the side wall of the right rotational unit 4, extending from the outer wall 4D of the right rotational unit 4 to the mountain-like right-side surface unit 4B (another one is also attached to the side wall of the left rotational section 5, extending from the outer surface 5D of the left rotational unit 5 to the mountain-like left-side surface 5B)

The rotational unit holding section 25 protrudes from the outer wall 4D (or 5D) and right-side surface unit 4B (or 5B) of the right rotational unit 4 (or 5) along the direction of the horizontal rotational shaft line L1: the rotational unit holding section 25 includes one side surface 25A and the other side surface 25B, and a top surface 25C and a back surface 25D (which are connected to form an L-shape).

By the way, the top surface 25C, which is substantially parallel to the plane at the summit of the right-side surface unit 4B (or 5B), is also referred to as holding unit top surface 25C.

The back surface 25D, which is substantially parallel to the horizontal rotational shaft line L1, is also referred to as holding unit back surface 25D.

The rotational unit holding section 25 contains mechanical components, such as a motor (not shown) and gears (not shown) which convey power from the motor.

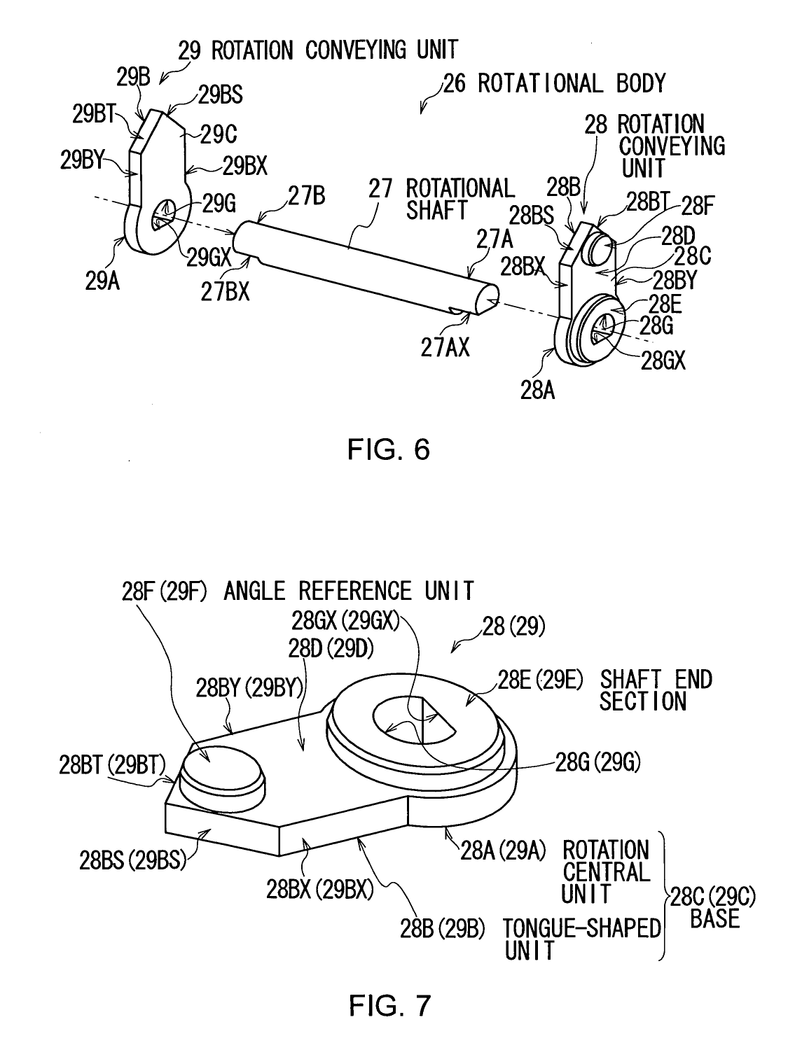

The rotation-side mechanical unit 20 includes a rotational body 26. As shown in FIG. 6, the rotational body 26 includes a cylindrical rotational shaft 27, and a pair of rotation conveying units 28 and 29, each of which is attached to a different end 27A or 27B of the rotational shaft 27. The rotation conveying units 28 and 29 are formed substantially in the same configuration.

Both sides (the sides of the ends 27A and 27B) of the rotational shaft 27 are formed into a D-shape, consequently forming planes 27AX and 27BX facing in the same direction.

As shown in FIG. 7, the rotation conveying units 28 and 29 have bases 28C and 29C including rotation central units 28A and 29A from which tongue-shaped units 28B and 29B protrude: the tongue-shaped units 28B and 29B are a plate whose width is narrower than the diameter of the rotation central units 28A and 29A.

The bases 28C and 29C have flat planes 28D and 29D extending from the rotation central units 28A and 29A to the tongue-shaped units 28B and 29B. Circular shaft end sections 28E and 29E protrudes from the planes 28D and 29D, being designed to support the ends 27A and 27B of the rotational shaft 27.

The center of the shaft end sections 28E and 29E is aligned with the center of the rotation central units 28A and 29A.

Circular angle reference units 28F and 29F, which will be used to set the rotation conveying units 28 and 29 in the right angle, are protruding from the planes 28D and 29D, near the V-shaped ends of the tongue-shaped units 28B and 29B.

The diameter of the angle reference units 28F and 29F is smaller than that of the shaft end sections 28E and 29E.

D-shaped holes are bored through the bases 28C and 29C along the central axes of the rotation central units 28A and 29A and shaft end sections 28E and 29E.

Flat planes 27GX and 28GX are formed along the inner walls of the holes 28G and 29G: where the planes 27GX and 28GX are formed is the farthest point from the tongue-shaped units 28B and 29B.

Accordingly, as shown in FIG. 6, the D-shaped ends of the rotational shafts 27 are inserted into the D-shaped holes 28G and 29G of the rotation conveying units 28 and 29 such that the planes 28D and 29D face in the opposite directions.

Since the planes 28D and 29D face the opposite directions, they are also referred to as outer surfaces 28D and 29D.

By the way, the rotational unit holding section 25 has a connecting hole 25AX connecting the inside to the outside, passing along the side of the right-side surface unit 4B (or 5B) and spacing the walls 25A and 25B from the right-side surface unit 4B (or 5B).

The center part of the rotational shaft 27 of the rotational body 26 is housed inside the rotational unit holding section 25 with both the ends 27A and 27B of the shaft 27 and the rotation conveying units 28 and 29 being exposed through the hole 25AX.

In this manner, the rotational unit holding section 25 holds the rotational body 26 (or the rotational shaft 27) so that the opening-and-closing units 6 and 7 can rotate around the rotational shaft 27 with respect to the rotational units 4 and 5. Therefore, the opening-and-closing units 6 and 7 can move in the closing direction D5 and the opening direction D6.

That is, the rotational unit holding section 25 allows the rotation conveying units 28 and 29, placed outside the side surfaces 25A and 25B, to rotate around the rotation central units 28A and 29A in the directions D5 and D6 with both the tongue-shaped units 28B and 29B pointing the same direction: the center of the rotational shaft 27 is aligned with the center of the rotation central units 28A and 29A.

The center of the rotational shaft 27 may be inserted in the center of a gear in the rotational unit holding section 25. This gear is engaged in another gear in the rotational unit holding section 25.

Accordingly, by running the motor, the rotation-side mechanical unit 20 can rotate the rotational body 26 around the rotational shaft 27 in the closing direction D5 and opening direction D6.

In addition, without using the motor, users can rotate the rotational body 26 by hand.

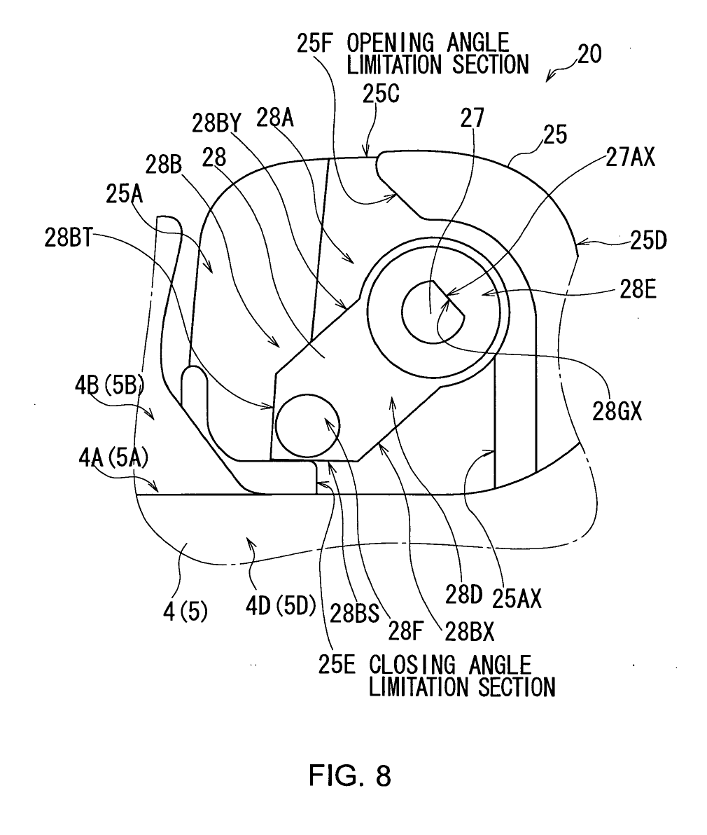

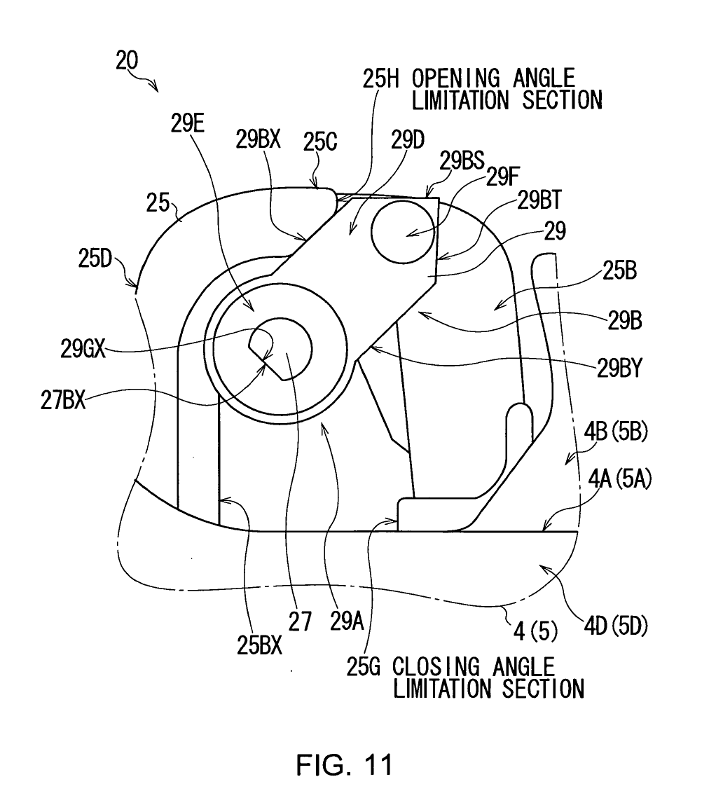

As shown in FIGS. 8 and 11, the rotation central units 28A and 29A exposed from the side surfaces 25A and 25B are positioned closer to the holding unit back surface 25D.

In addition, the tongue-shaped units 28B and 29B exposed from the side walls 25A and 25B are positioned closer to the line L1 than the rotational central units 28A and 29A.

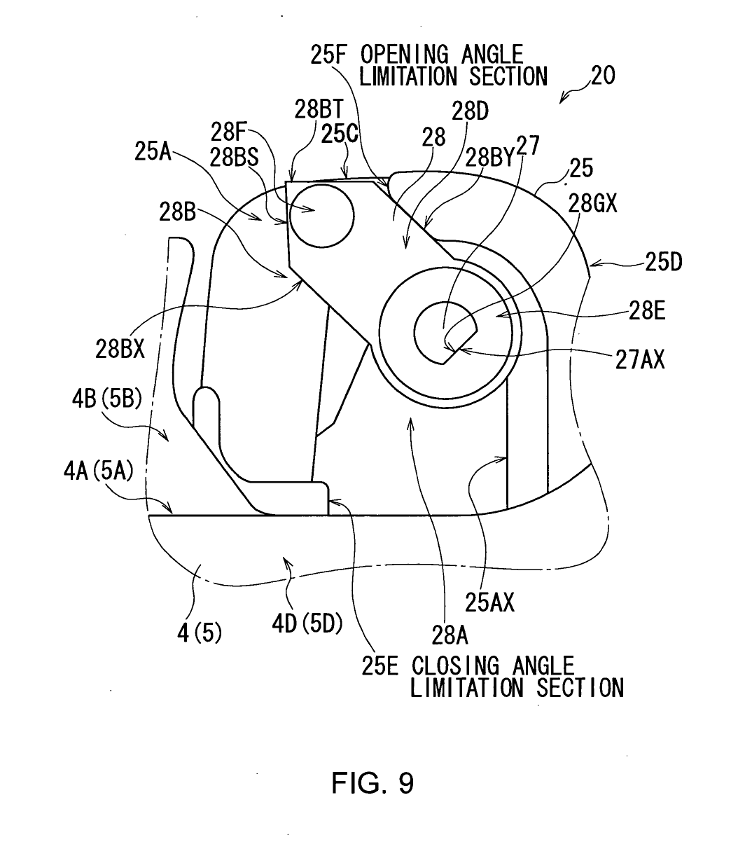

As shown in FIGS. 8 and 9, the one side surface 25A is equipped with a protruding closing angle limitation section 25E to stop the rotational body 26 rotating in the closing direction D5: the closing angle limitation section 25E is positioned near the right-side edge 4A (or the left-side edge 5A) of the right rotational unit 4 or (the left rotational unit 5) The one side surface 25A is also equipped with a protruding opening angle limitation section 25F to stop the rotational body 26 rotating in the opening direction D6: the opening angle limitation section 25F is positioned near the holding unit top surface 25C.

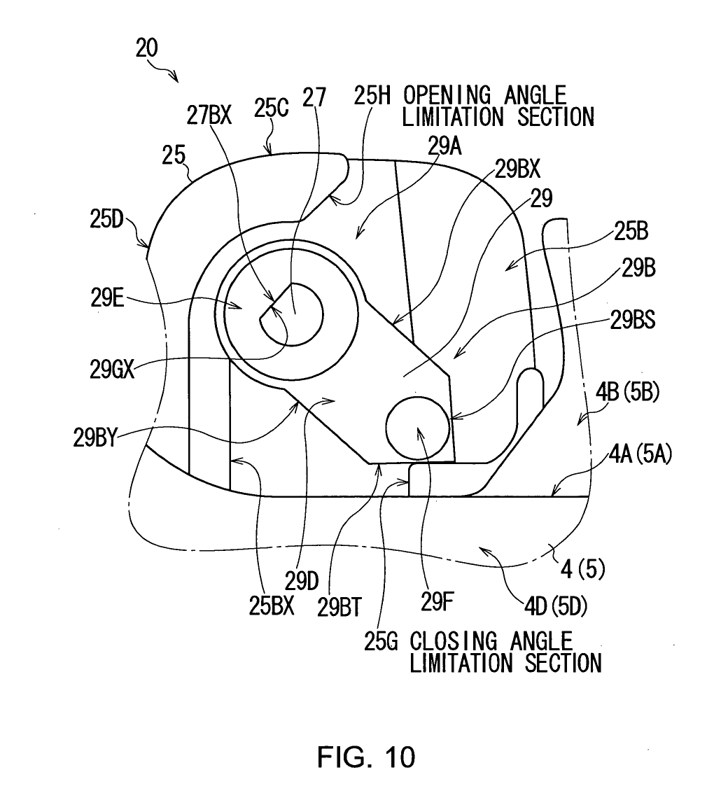

As shown in FIGS. 10 and 11, the other side surface 25B of the rotational unit holding section 25 is configured in the same way as the one side surface 25A.

That is, the other side surface 25B is equipped with a protruding closing angle limitation section 25G to stop the rotational body 26 rotating in the closing direction D5: the closing angle limitation section 25G is positioned near the right-side edge 4A (or the left-side edge 5A) of the right rotational unit 4 or (the left rotational unit 5).

The other side surface 25B is also equipped with a protruding opening angle limitation section 25H to stop the rotational body 26 rotating in the opening direction D6: the opening angle limitation section 25H is positioned near the holding unit top surface 25C.

Hereinafter, the positions where the closing angle limitation sections 25E and 25G are provided are also referred to as “near-edge position,” which is on the one side surface 25A or the other side surface 25B.

Hereinafter, the positions where the opening angle limitation sections 25F and 25H are provided are also referred to as “near-wall position,” which is on the one side surface 25A or the other side surface 25B.

When the rotational body 26 is fully rotated in the closing direction D5, the rotation conveying unit 28 hits the closing angle limitation section 25E: the one edge 28BS (one side of the V-shaped portion which also has another edge 28BT) of the tongue-shaped unit 28B touches the closing angle limitation section 25E.

And also the rotation conveying unit 29 hits the closing angle limitation section 25G: the one edge 29BT (one side of the V-shaped portion which also has another edge 29BS) of the tongue-shaped unit 29B touches the closing angle limitation section 25G.

In this manner, the closing angle limitation sections 25E and 25G limit the rotation of the rotational body 26 in the closing direction D5 to a “closing direction limitation angle,” an angle at which the tongue-shaped units 28B and 29B are positioned around the near-edge position.

When the rotational body 26 is fully rotated in the opening direction D6, the rotation conveying unit 28 hits the opening angle limitation section 25F: the other side 28BY of the tongue-shaped unit 28B (which also has the one side 28BX) touches the opening angle limitation section 25F.

And also the rotation conveying unit 29 hits the opening angle limitation section 25H: the one side 29BX of the tongue-shaped unit 29B (which also has the other side 29BY) touches the opening angle limitation section 25H.

In this manner, the opening angle limitation sections 25F and 25H limit the rotation of the rotational body 26 in the opening direction D6 to an “opening direction limitation angle,” an angle at which the tongue-shaped units 28B and 29B are positioned around the near-wall position.

In that manner, the closing angle limitation sections 25E and 25G limit the rotation of the rotational body 26 in the closing direction D5 to the closing direction limitation angle, to make the angle of the right opening-and-closing unit 6 with respect to the right rotational unit 4 (and the angle of the left opening-and-closing unit 7 with respect to the left rotational unit 5) zero degree, or close it.

The opening angle limitation sections 25F and 25H limit the rotation of the rotational body 26 in the opening direction D6 to the opening direction limitation angle, to make the angle of the right opening-and-closing unit 6 with respect to the right rotational unit 4 (and the angle of the left opening-and-closing unit 7 with respect to the left rotational unit 5) for example 80 degree, or open it.

That is, the closing angle limitation sections 25E and 25G, and the opening angle limitation sections 25F and 25H limit the rotation of the rotational body 26 between the closing direction limitation angle, or 0 degree, and the opening direction limitation angle, or for example 80 degrees, or a rotational angle range.

In that manner, the rotation conveying units 28 and 29 of the rotational body 26 is placed in the rotation-side mechanical unit 20 so that their tongue-shaped units 28B and 29B are closer to the horizontal rotational shaft line L1 than their rotation central units 28A and 29A are. The rotational body 26 is allowed by the closing angle limitation sections 25E and 25G and the opening angle limitation sections 25F and 25H to rotate within the rotational angle range.

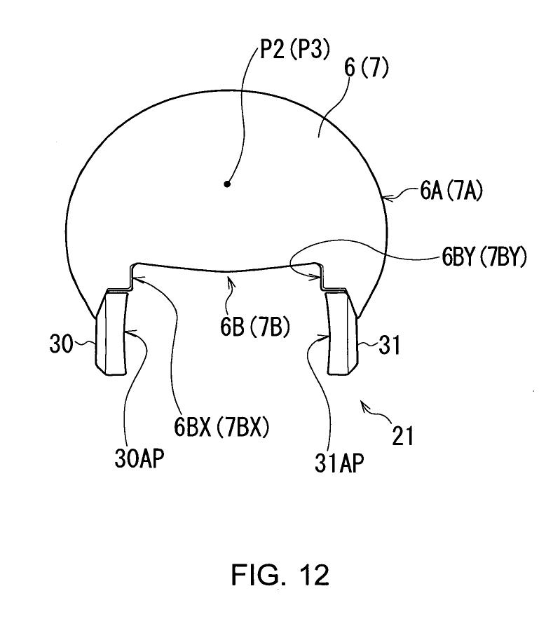

As shown in FIG. 12, the edges of the right opening-and-closing unit 6 and the left opening-and-closing unit 7 are cut off to form substantially C-shaped cut-off sections 6B and 7B, which extends toward the summits P2 and P3.

The opening-and-closing-side mechanical unit 21 has a pair of rotational body pinching units 30 and 31 to hold the rotational body 26. The facing planes 30AP and 31AP of the rotational body pinching units 30 and 31 hold the outer surfaces 28D and 29D of the rotational body 26. The rotational body pinching units 30 and 31 are attached to the cut-off sides 6BX and 6BY (7BX and 7BY) of the cut-off section 6B (7B) such that they are close to the edge 6A (or 7A).

The distance between the facing planes 30AP and 31AP is substantially equal to the length of the rotational body 26.

The length of the rotational body 26 means the distance from the outer surface 28D of the rotation conveying unit 28 to the outer side 29D of the rotation conveying unit 29.

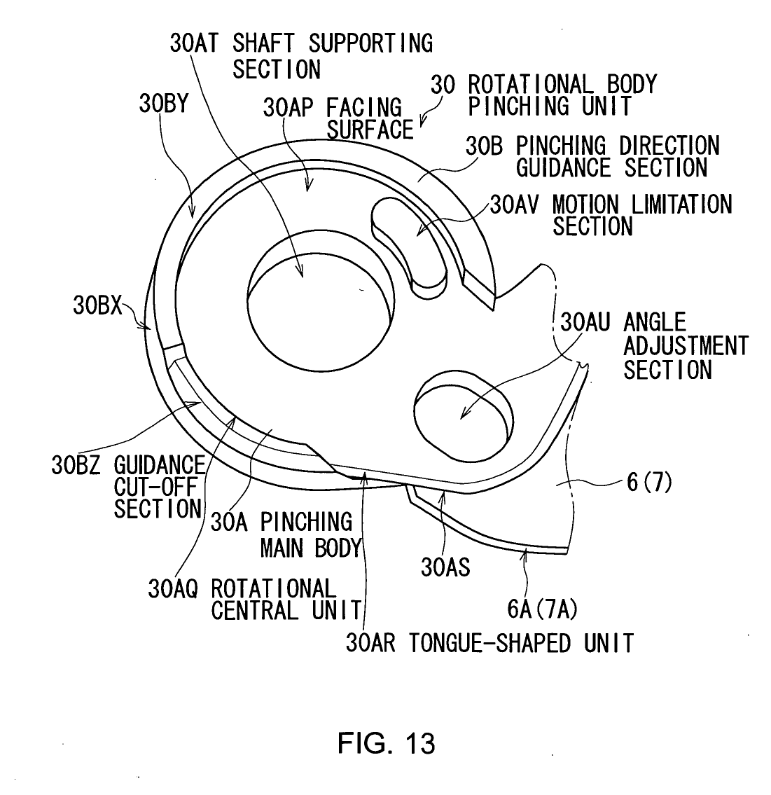

As shown in FIG. 13, the rotational body pinching unit 30 has a pinching main body 30A which is formed with the opening-and-closing unit 6 (or 7) in one unit. The pinching main body 30A made from resin such as synthetic resin.

The pinching main body 30A includes a substantially circular plate 30AQ (referred to as “rotational central unit”), from which a tongue-shaped plate 30AR (referred to as “tongue-shaped unit”) extends.

The plate 30AQ's surface extending from the rotational central unit 30AQ to the tongue-shaped unit 30AR serves as the facing surface 30AP of the rotational body pinching unit 30.

The other surface 30AS of the tongue-shaped unit 30AR of the rotational body pinching unit 30 is attached to the cut-off side 6BX such that it is close to the edge 6A (or 7A).

The rotational central unit 30AQ of the pinching main body 30A is positioned above the surface of the opening-and-closing unit 6 (or 7), inclining more toward the summit P2 (or P3) than toward the edge 6A (or 7A).

The facing plane 30AP of the pinching main body 30A has a circular, concave shaft supporting section 30AT around the center of the rotational central unit 30AQ. The shaft supporting section 30AT corresponds to the shaft end section 28E of the rotation conveying unit 28.

The facing plane 30AP of the pinching main body 30A also has a concave angle adjustment section 30AU around the tongue-shaped unit 30AR. The angle adjustment section 30AU corresponds to the angle reference unit 28F of the rotation conveying unit 28, and is used to limit its rotation to the same range of the rotational body 26.

In this case, the concave angle adjustment section 30AU is formed like an “oval track,” the length of which is aligned with a line connecting the shaft supporting section 30AT and the angle adjustment section 30AU.

The shaft supporting section 30AT and the angle adjustment section 30AU are positioned in the following manner: when holding the rotational body 26 and limiting its rotation (or the rotation of the opening-and-closing unit 6 (or 7) with respect to the rotational unit 4 (or 5)), the shaft supporting section 30AT faces the shaft end section 28E of the rotation conveying unit 28, and the angle adjustment section 30AU faces the angle reference unit 28F.

The facing plane 30AP of the pinching main body 30A also has a motion limitation section 30AV to limit, when the rotational body 26 is held by the pinching main body 30A, the relative motion of the rotation conveying unit 28 on the facing surface 30AP. The motion limitation section 30AV is a substantially circular convex section formed around the rotational central unit 30AQ, extending, as if drawing an arc, along the circular shaft supporting section 30AT.

In addition, the rotational body pinching unit 30 has a pinching direction guidance section 30B to guide the direction (or pinching direction) of the facing surfaces 30AP and 31AP sliding on the outer surfaces 28D and 29D (when the rotational body 26 is pinched or held by the facing surfaces 30AP and 31AP).

The pinching direction guidance section 30B is formed like a circular pipe with its bottom capped, into which the rotational central unit 30AQ of the pinching main body 30A is situated with the other surface 30AS touching the bottom of the pinching direction guidance section 30B.

The outer wall 30BX of the pinching direction guidance section 30B slightly extends in a direction perpendicular to the facing surface 30AP. On the outer wall 30BX is the outer wall edge section 30BY.

A guidance cut-off section 30BZ is formed in a certain area of the outer wall 30BX of the pinching direction guidance section 30B, which is close to the edge 6A (or 7A) of the opening-and-closing unit 6 (or 7), by cutting the outer wall 30BX off to the level equal to the surface of the facing surface 30AP. The guidance cut-off section 30BZ is used to guide the pinching direction of the rotational body 26 pinched by the facing surface 30AP.

The guidance cut-off section 30BZ has a C-chamfered face or a round chamfered face to make the outer edge lower than the facing surface 30AP.

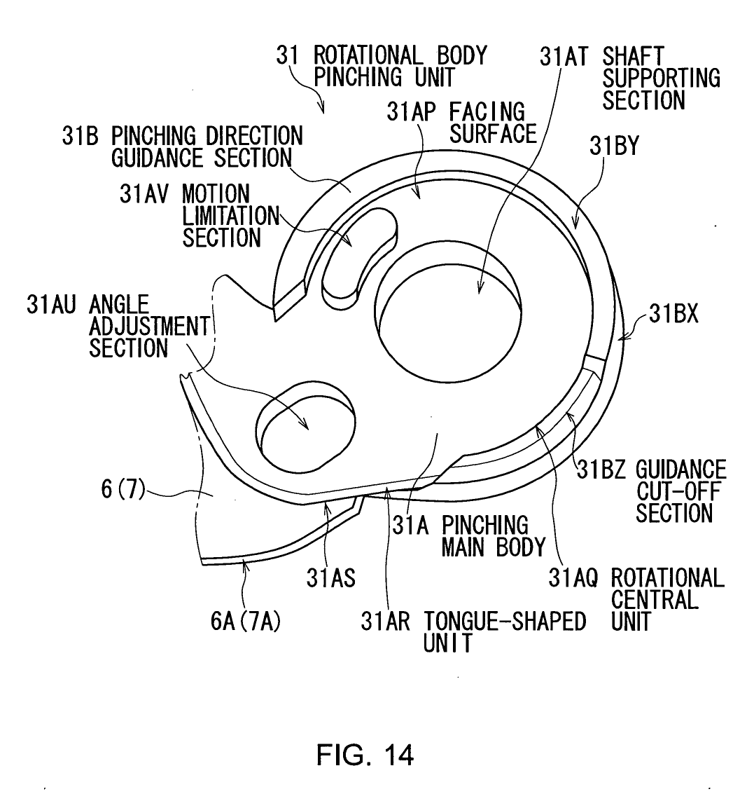

As shown in FIG. 14, the rotational body pinching unit 31 is substantially configured in the same way as the rotational body pinching unit 30.

That is, the rotational body pinching unit 31 has a pinching main body 31A which is formed with the opening-and-closing unit 6 (or 7) in one unit. The pinching main body 31A made from resin such as synthetic resin.

The pinching main body 31A includes a substantially circular plate 31AQ (referred to as “rotational central unit”), from which a tongue-shaped plate 31AR (referred to as “tongue-shaped unit”) extends.

The plate 31AQ's surface extending from the rotational central unit 31AQ to the tongue-shaped unit 31AR serves as the facing surface 31AP of the rotational body pinching unit 31.

The other surface 31AS of the tongue-shaped unit 31AR of the rotational body pinching unit 31 is attached to the cut-off side 6BX (7BX) such that it is close to the edge 6A (or 7A).

The rotational central unit 31AQ of the pinching main body 31A is positioned above the surface of the opening-and-closing unit 6 (or 7), inclining more toward the summit P2 (or P3) than toward the edge 6A (or 7A).

The facing plane 31AP of the pinching main body 31A has a circular, concave shaft supporting section 31AT around the center of the rotational central unit 31AQ. The shaft supporting section 31AT corresponds to the shaft end section 29E of the rotation conveying unit 29.

The facing plane 31AP of the pinching main body 31A also has a concave angle adjustment section 31AU around the tongue-shaped unit 31AR. The angle adjustment section 31AU corresponds to the angle reference unit 29F of the rotation conveying unit 29, and is used to limit its rotation to the same range of the rotational body 26.

In this case, the concave angle adjustment section 31AU is formed like an “oval track,” the length of which is aligned with a line connecting the shaft supporting section 31AT and the angle adjustment section 31AU.

The shaft supporting section 31AT and the angle adjustment section 31AU are positioned in the following manner: when holding the rotational body 26 and limiting its rotation (or the rotation of the opening-and-closing unit 6 (or 7) with respect to the rotational unit 4 (or 5)), the shaft supporting section 31AT faces the shaft end section 29E of the rotation conveying unit 29, and the angle adjustment section 31AU faces the angle reference unit 29F.

The facing plane 31AP of the pinching main body 31A also has a motion limitation section 31AV to limit, when the rotational body 26 is held by the pinching main body 31A, the relative motion of the rotation conveying unit 29 on the facing surface 31AP. The motion limitation section 31AV is a substantially circular convex section formed around the rotational central unit 31AQ, extending, as if drawing an arc, along the circular shaft supporting section 31AT.

In addition, the rotational body pinching unit 31 has a pinching direction guidance section 31B to guide the pinching direction when the rotational body 26 is pinched or held by the facing surfaces 30AP and 31AP.

The pinching direction guidance section 31B is formed like a circular pipe with its bottom capped, into which the rotational central unit 31AQ of the pinching main body 31A is situated with the other surface 31AS touching the bottom of the pinching direction guidance section 31B.

The outer wall 31BX of the pinching direction guidance section 31B slightly extends in a direction perpendicular to the facing surface 31AP. On the outer wall 31BX is the outer wall edge section 31BY.

A guidance cut-off section 31BZ is formed in a certain area of the outer wall 31BX of the pinching direction guidance section 31B, which is close to the edge 6A (or 7A) of the opening-and-closing unit 6 (or 7), by cutting the outer wall 31BX off to the level equal to the surface of the facing surface 31AP. The guidance cut-off section 31BZ is used to guide the pinching direction of the rotational body 26 pinched by the facing surface 31AP.

The guidance cut-off section 31BZ has C-chamfered face or a round chamfered face to make the outer edge lower than the facing surface 30AP.

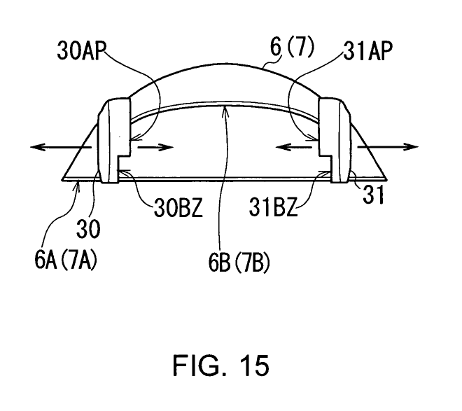

As shown in FIG. 15, the right and left opening-and-closing units 6 and 7 are made from a thin material such as synthetic resin. The cut-off sections 6B and 7B are formed.

If the force is applied to widen the gap of the cut-off sections 6B and 7B in the horizontal direction in FIG. 15 (as if pushing the cut-off sides 6BX and 6BY and 7BX and 7BY), the right and left opening-and-closing units 6 and 7 may be deformed.

Since the right and left opening-and-closing units 6 and 7 are elastic, they return to the original shape when the force is removed.

The tongue-shaped units 30AR and 31AR of the pinching main bodies 30A and 31A of the rotational body pinching units 30 and 31 are made of a thin material.

The pinching main bodies 30A and 31A are attached to the cut-off sides 6BX and 6BY and 7BX and 7BY of the right and left opening-and-closing units 6 and 7 such that they protrude beyond the right and left opening-and-closing units 6 and 7.

Accordingly, if the force is applied to widen the distance between the rotational body pinching units 30 and 31, the gap between the rotational body pinching units 30 and 31 will widen as if forming a V shape with two lines, one of which connects the tongue-shaped unit 30AR and the rotational central unit 30AQ and the other of which connects the tongue-shaped unit 31AR and the rotational central unit 31AQ, with fulcrums, one of which is around where the pinching main body 30A is connected to the cut-off sides 6BX and 7BX and the other of which is around where the pinching main body 31A is connected to the cut-off sides 6BY and 7BY.

That is, the distance between the rotational central units 30AQ and 31AQ is broader than the distance between the tongue-shaped unit 30AR and the tongue-shaped unit 31AR.

But the material around where the pinching main body 30A is connected to the cut-off sides 6BX and 7BX and where the pinching main body 31A is connected to the cut-off sides 6BY and 7BY is elastic.

Accordingly, once the force is removed, the pinching main bodies 30A and 31A return to the original positions so that the surface 30AP is parallel to the other surface 31AP.

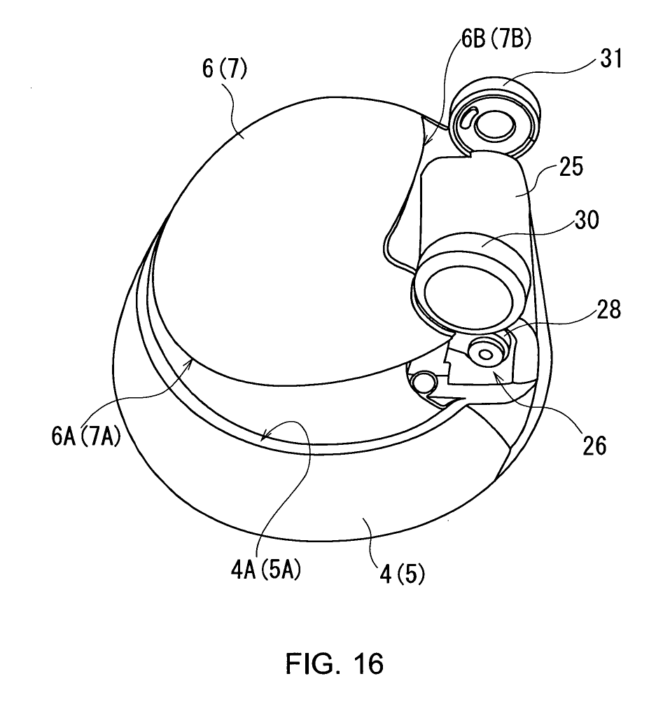

As shown in FIG. 16, when the right opening-and-closing unit 6 is attached to the rotational body 26, the inner surface of the right opening-and-closing unit 6 faces the right speaker 10 (or the inner surface of the left opening-and-closing unit 7 faces the left speaker 11). The rotational body pinching units 30 and 31 are pushed toward the rotational unit holding section 25 as if inserting the rotational body 26 between the facing surfaces 30AP and 31AP.

At this time, the facing surface 30AP is put on the shaft end section 28E and the angle reference unit 28F while the facing surface 31AP is put on the shaft end section 29E and the angle reference unit 29F of the other side.

As a result, thanks to the shaft end section 28E and the angle reference unit 28F and the shaft end section 29E and the angle reference unit 29F, the distance between the facing surfaces 30AP and 31Ap is widened.

In this manner, when the rotational body 26 is inserted between the surfaces 30AP and 31AP, the shaft end section 28E of the rotation conveying unit 28 is put on the shaft supporting section 30AT of the rotational body pinching unit 30. Finally, the shaft end section 28E fits into the shaft supporting section 30AT.

Also the shaft end section 29E of the rotation conveying unit 29 is put on the shaft supporting section 31AT of the rotational body pinching unit 31. Finally, the shaft end section 29E fits into the shaft supporting section 31AT.

Moreover, the angle adjustment section 30AU of the rotational body pinching unit 30 fits into the angle reference unit 28F of the rotation conveying unit 28.

Furthermore, the angle adjustment section 31AU of the rotational body pinching unit 31 fits into the angle reference unit 29F of the rotation conveying unit 29.

In that manner, when the convex shaft end sections 28E and 29E fit in the concave shaft supporting sections 30AT and 31AT, and when the concave angle adjustment sections 30AU and 31AU fit into the convex angle reference units 28F and 29F, the facing surfaces 30AP and 31AP touch the outer surfaces 28D and 29D of the rotation conveying units 28 and 29, returning to the original positions.

In that manner, the surfaces 30AP and 31AP of the rotational body pinching units 30 and 31 hold the outer surfaces 28D and 29D of the rotational body 26 as if pinching the rotational body 26. In this manner, the opening-and-closing unit 6 (or 7) is attached to the rotational body 26.

The shaft end sections 28E and 29E, whose centers are aligned with the center of the rotational shaft 27 as mentioned above, fit into the shaft supporting sections 30AT and 31AT. In addition, the angle reference units 28F and 29F, which is positioned away from the shaft end sections 28E and 29E, fit into the angle adjustment sections 30AU and 31AU.

In that manner, the rotational body pinching units 30 and 31, which holds the rotation conveying units 28 and 29 of the rotationally body 26, rotates in the closing and opening directions D5 and D6 in concert with the rotational body 26.

That is, the rotation of the rotational body 26 by, for example, a motor around the rotational shaft 27 is conveyed to the rotation conveying units 28 and 29.

Therefore, the rotational body pinching units 30 and 31 rotate around the rotational central units 30AQ and 31AQ in the closing and opening directions D5 and D6 in concert with the rotational body 26.

If the opening-and-closing unit 6 or 7 is opened or closed by a user, or is rotated around the rotational central units 30AQ and 31AQ with respect to the rotational unit 4 or 5, the rotation of the opening-and-closing unit 6 or 7 is conveyed to the rotation conveying units 28 and 29 of the rotational body 26.

As a result, the rotational body pinching units 30 and 31 rotate around the rotational central units 30AQ and 31AQ in the closing and opening directions D5 and D6 in concert with the rotational body 26.

The shape of the rotational body pinching units 30 and 31 and the arrangement of their components (such as the angle adjustment sections 30AU and 31AU) are appropriately selected to allow the rotational body pinching units 30 and 31 to rotate until the angle of the opening-and-closing unit 6 (or 7) with respect to the rotational unit 4 (or 5) becomes the closing direction limitation angle, or 0 degree, or the opening direction limitation angle, or around 80 degrees.

In that manner, in the rotational body pinching units 30 and 31, the shaft end sections 28E and 29E fit into the shaft supporting sections 30AT and 31AT. In addition, the angle reference units 28F and 29F fit into the angle adjustment sections 30AU and 31AU. The opening-and-closing unit 6 (or 7) is attached to the rotational body 26 so that the rotational range of the rotational body 26 becomes equal to the opening-and-closing range of the opening-and-closing unit 6 (or 7) with respect to the rotational unit 4 (or 5).

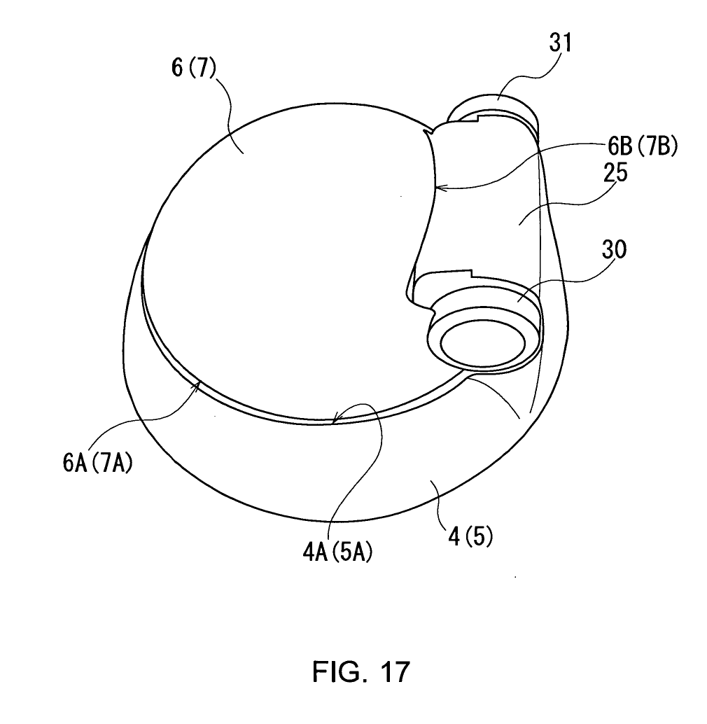

As shown in FIG. 17, when the rotational body pinching units 30 and 31 and the rotational body 26 are rotated until they reach the closing direction limitation angle, or 0 degree, the opening-and-closing unit 6 (or 7) closes completely such that it covers the rotational unit 4 (or 5).

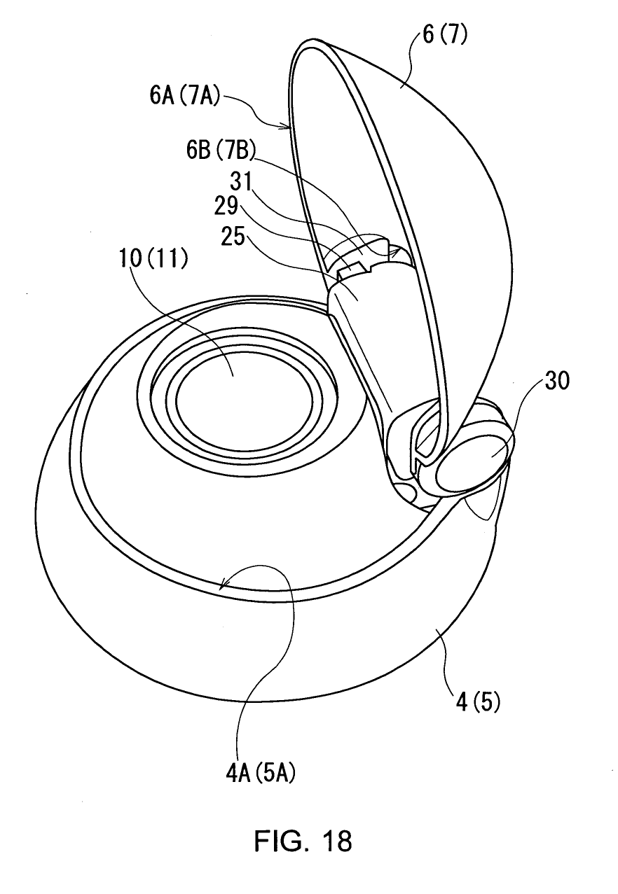

As shown in FIG. 18, when the rotational body pinching units 30 and 31 and the rotational body 26 are rotated until they reach the opening direction limitation angle, or about 80 degree, the opening-and-closing unit 6 (or 7) opens completely such that it exposes the rotational unit 4 (or 5).

As for the rotation conveying units 28 and 29 of the rotational body 26 (FIG. 7), the top surfaces of the shaft end sections 28E and 29E are flat, but their edges have a C-chamfered face or a round chamfered face.

Moreover, the top surfaces of the angle reference units 28F and 29F are flat, but their edges have a C-chamfered face or a round chamfered face.

The guidance cut-off sections 30BZ and 31BZ of the pinching direction guidance sections 30B and 31B of the rotational body pinching units 30 and 31 (FIGS. 13 and 14) are also chamfered.

Accordingly, as for the rotational body pinching units 30 and 31, the opening-and-closing unit 6 (or 7) can be easily attached to the rotational body 26. That is, the rotational body 26 is inserted into the rotational unit holding section 25 such that guidance cut-off sections 30BZ and 31BZ face the rotation conveying units 28 and 29 respectively. At this time, since the edges of the shaft end sections 28E and 29E and angle reference units 28F and 29F and guidance cut-off sections 30BZ and 31BZ are chamfered, the facing surfaces 30AP and 31AP easily engage in the shaft end sections 28E and 29E and the angle reference units 28F and 29F.

As mentioned above, when the facing surfaces 30AP and 31AP are put on the shaft end sections 28E and 29E, the rotational body pinching units 30 and 31 are deformed. The distance between the facing surfaces 30AP and 31AP widens.

Since the rotational body pinching units 30 and 31 are elastic, the facing surfaces 30AP and 31AP pushes the outer surfaces 28D and 29D of the rotation conveying units 28 and 29.

The pushing of the facing surfaces 30AP and 31AP help bring the shaft end sections 28E and 29E to the shaft supporting sections 30AT and 31AT, since the edges of the shaft end sections 28E and 29E are chamfered. Finally, the shaft end sections 28E and 29E fit into the shaft supporting sections 30AT and 31AT.

In this manner, the shaft end sections 28E and 29E can easily brought to the shaft supporting sections 30AT and 31AT.

The pushing of the facing surfaces 30AP and 31AP also help bring the angle reference units 28F and 29F to the angle adjustment sections 30AU and 31AU, since the edges of the angle reference units 28F and 29F are chamfered. Finally, the angle reference units 28F and 29F fit into the angle adjustment sections 30AU and 31AU.

In this manner, the angle reference units 28F and 29F can easily brought to the angle adjustment sections 30AU and 31AU.

Furthermore, the diameter of the angle reference units 28F and 29F is smaller than the diameter of the shaft end sections 28E and 29E.

As for the rotational body pinching units 30 and 31, in accordance with the diameter of the shaft end sections 28E and 29E of the rotation conveying units 28 and 29 and the diameter of the angle reference units 28F and 29F, the width of the angle adjustment sections 30AU and 31AU is smaller than the diameter of the shaft supporting sections 30AT and 31AT.

This prevents the shaft end sections 28E and 29E from fitting in the angle adjustment sections 30AU and 31AU. The shaft end sections 28E and 29E fit in the shaft supporting sections 30AT and 31AT. The angle reference units 28F and 29F fit in the angle adjustment sections 30AU and 31AU.

Accordingly, the opening-and-closing unit 6 (or 7) is attached to the rotational body 26 so that the rotational range of the rotational body 26 becomes equal to the opening-and-closing range of the opening-and-closing unit 6 (or 7) with respect to the rotational unit 4 (or 5).

Moreover, the angle adjustment sections 30AU and 31AU are formed like a concave “oval track.”

If the rotational body pinching units 30 and 31 are not manufactured precisely due to production failure, the distance from the center of the shaft end sections 28E and 29E to the center of the angle reference units 28F and 29F may vary. But the oval-track-shaped angle adjustment sections 30AU and 31AU can compensate for this. Accordingly, the shaft end sections 28E and 29E and the angle reference units 28F and 29F fit in the shaft supporting section 30AT and 31AT and the angle adjustment sections 30AU and 31AU.

In addition, as for the rotational body pinching units 30 and 31, the outer walls 30BX and 31BX of the pinching direction guidance sections 30B and 31B protrude more than the facing surfaces 30AP and 31AP, except the portions close to the edges 6A and 7A of the opening-and-closing unit 6 (or 7).

Accordingly, if the opening-and-closing unit 6 (or 7) is turned upside down and is inserted into the rotational body 26 toward the rotational unit holding section 25 such that its outer surface faces the speaker 10 (or 11), the outer walls 30BX and 31BX and the outer wall edge sections 30BY and 31BY hit the sides of the shaft end sections 28E and 29E and angle reference units 28F and 29F.

This prevents the opening-and-closing unit 6 (or 7) from being attached in an inappropriate manner.

This prevents the outer surface of the opening-and-closing unit 6 (or 7) from damaging the diaphragm of the speaker 10 (or 11).

In the opening-and-closing mechanical units 8 and 9, the rotational body 26 is rotated not only by a motor but by an external force.

Accordingly, after the opening-and-closing unit 6 (or 7) is attached to the rotational body 26, as mentioned above in reference to FIGS. 8 and 10, the angle reference units 28F and 29F of the rotation conveying units 28 and 29 may be closer to the edges 4A (or 5A) than the shaft end sections 28E and 29E are i.e., the angle may be the closing direction limitation angle.

Moreover, after the opening-and-closing unit 6 (or 7) is attached to the rotational body 26, as mentioned above in reference to FIGS. 9 and 11, the angle reference units 28F and 29F of the rotation conveying units 28 and 29 may be closer to the holding unit top surface 25C than the shaft end sections 28E and 29E are i.e., the angle may be the opening direction limitation angle.

Furthermore, after the opening-and-closing unit 6 (or 7) is attached to the rotational body 26, the angle reference units 28F and 29F and the shaft end sections 28E and 29E may be arranged in a line parallel to the holding unit top surface 25C (or perpendicular to the line L1).

In that manner, after the opening-and-closing unit 6 (or 7) is attached to the rotational body 26, no one knows the angle of the opening-and-closing unit 6 (or 7).

As for the opening-and-closing mechanical units 8 and 9, with the opening-and-closing unit 6 (or 7) or the rotational body pinching units 30 and 31 held by hand, the opening-and-closing unit 6 (or 7) is attached to the rotational body 26.

Accordingly, how the opening-and-closing unit 6 (or 7) is attached to the rotational body 26 (or the attitude of the rotational body pinching units 30 and 31) depends on users.

As for the rotational body pinching units 30 and 31, for example, as mentioned above in reference with FIG. 16, the opening-and-closing unit 6 (or 7) may be inserted into the rotational body 26 toward the rotational unit holding section 25 in the following manner: the inner central part of the opening-and-closing unit 6 (or 7) faces the speaker 10 (or 11), and the angle adjustment sections 30AU and 31AU are closer to the rotational unit holding section 25 than the shaft supporting sections 30AT and 31AT are.

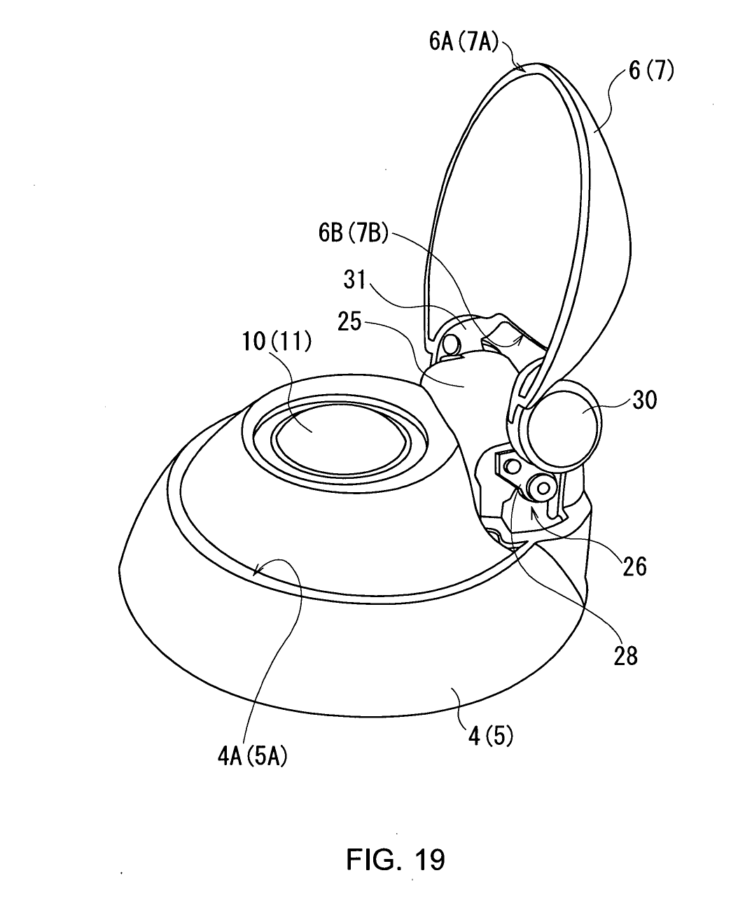

Moreover, as shown in FIG. 19, as for the rotational body pinching units 30 and 31, the opening-and-closing unit 6 (or 7) may be inserted into the rotational body 26 toward the rotational unit holding section 25 in the following manner: despite the inner central part of the opening-and-closing unit 6 (or 7) facing the speaker 10 (or 11), the angle of the opening-and-closing unit 6 (or 7) with respect to the rotational unit 4 (or 5) is maximum, and the shaft supporting sections 30AT and 31AT are closer to the rotational unit holding section 25 than the angle adjustment sections 30AU and 31AU are.

Moreover, as for the rotational body pinching units 30 and 31, the opening-and-closing unit 6 (or 7) may be inserted into the rotational body 26 toward the rotational unit holding section 25 in the following manner: despite the inner central part of the opening-and-closing unit 6 (or 7) facing the speaker 10 (or 11), the angle of the opening-and-closing unit 6 (or 7) with respect to the rotational unit 4 (or 5) is medium, and the shaft supporting sections 30AT and 31AT and the angle adjustment sections 30AU and 31AU are therefore arranged in a line parallel to the holding unit top surface 25C (or perpendicular to the line L1).

In that manner, when the opening-and-closing unit 6 (or 7) is attached to the rotational body 26, no one knows the attitude of the rotational body pinching units 30 and 31.

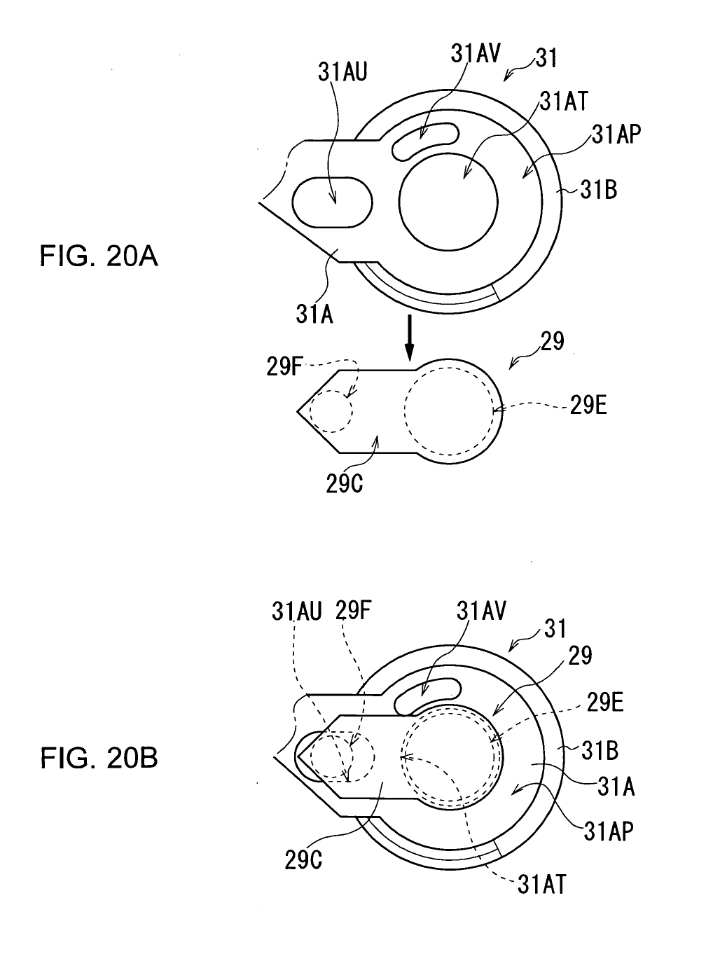

Accordingly, as shown in FIG. 20A, after the opening-and-closing unit 6 (or 7) is attached to the rotational body 26, the direction of an imaginary line drawn from the shaft supporting sections 30AT and 31AT to the angle adjustment sections 30AU and 31AU (referred to as “pinching section direction”) may be aligned with the direction of an imaginary line drawn from the shaft end sections 28E and 29E to the angle reference units 28F and 29F (referred to as “rotational body direction”).

In such a case, as shown in FIG. 20B, when the rotational body pinching units 30 and 31 are pushed toward the rotational unit holding section 25 to accept the rotational body 26 between the facing surfaces 30AP and 31AP, the facing surfaces 30AP and 31AP are put on the shaft end sections 28E and 29E.

At this time, as for the rotational body pinching units 30 and 31, the distance between the facing surfaces 30AP and 31AP widens along the tongue-shaped units 30AR and 31AR to the rotational central units 30AQ and 31AQ.

This allows the rotational body pinching units 30 and 31 to go up the angle reference units 28F and 29F.

If the pinching section direction is aligned with the rotational body direction, the angle reference units 28F and 29F are aligned with the angle adjustment sections 30AU and 31AU by aligning the shaft end sections 28E and 29E with the shaft supporting sections 30AT and 31AT.

In this manner, the shaft end sections 28E and 29E fit into the shaft supporting sections 30AT and 31AT, and the angle reference units 28F and 29F fit into the angle adjustment sections 30AU and 31AU.

In this manner, despite whatever attitude the rotational body pinching units 30 and 31 take, if the pinching section direction is aligned with the rotational body direction, by pushing the rotational body pinching units 30 and 31 toward rotational unit holding section 25 so as to accept the rotational body 26 between the surfaces 30AP and 31AP, the rotational range of the rotational body 26 is aligned with the opening-and-closing range of the opening-and-closing unit 6 (or 7) with respect to the rotational unit 4 (or 5).

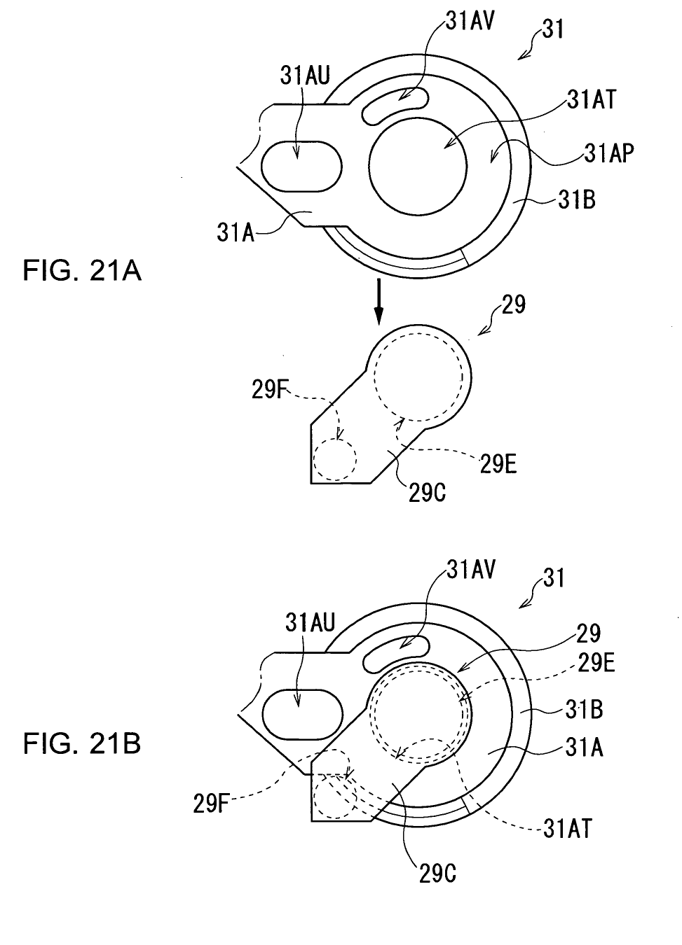

Moreover, as shown in FIG. 21A, as for the opening-and-closing mechanical units 8 and 9, the opening-and-closing unit 6 (or 7) may be attached to the rotational body 26 in the following manner: the opening-and-closing unit 6 (or 7) is opened with respect to rotational unit 4 (or 5), while the rotational body 26 has been rotated in the closing direction D5. In this case, the pinching section direction is not aligned with the rotational body direction, with the lines of the two directions forming a shape of “V”.

In this case, as shown in FIG. 21B, when the rotational body pinching units 30 and 31 are pushed toward the rotational unit holding section 25 so as to accept the rotational body 26 between the facing surfaces 30AP and 31AP, the facing surfaces 30AP and 31AP are put on the shaft end sections 28E and 29E.

Subsequently, when the shaft end sections 28E and 29E face the shaft supporting sections 30AT and 31AT, the shaft end sections 28E and 29E fit in the shaft supporting sections 30AT and 31AT.

Even though the shaft end sections 28E and 29E fit in the shaft supporting sections 30AT and 31AT, the angle reference units 28F and 29F may be positioned outside of the facing surfaces 30AP and 31AP, because the pinching section direction is not aligned with the rotational body direction.

Moreover, as for the rotational body pinching units 30 and 31, when the shaft end sections 28E and 29E fit in the shaft supporting sections 30AT and 31AT, the side of the angle reference units 28F and 29F may touch the sides of the tongue-shaped units 30AR and 31AR (the sides close to the edge 6A (or 7A) of the opening-and-closing unit 6 (or 7) and also close to the boundary between the tongue-shaped units 30AR and 31AR and the rotational central units 30AQ and 31AQ).

By the way, the outer diameter of the shaft end sections 28E and 29E is slightly smaller than the inside diameter of the shaft supporting sections 30AT and 31AT.

Accordingly, if the shaft end sections 28E and 29E are engaged in the shaft supporting sections 30AT and 31AT without the angle reference units 28F and 29F engaged in the angle adjustment sections 30AU and 31AU, the shaft supporting sections 30AT and 31AT can be rotated in the shaft end sections 28E and 29E.

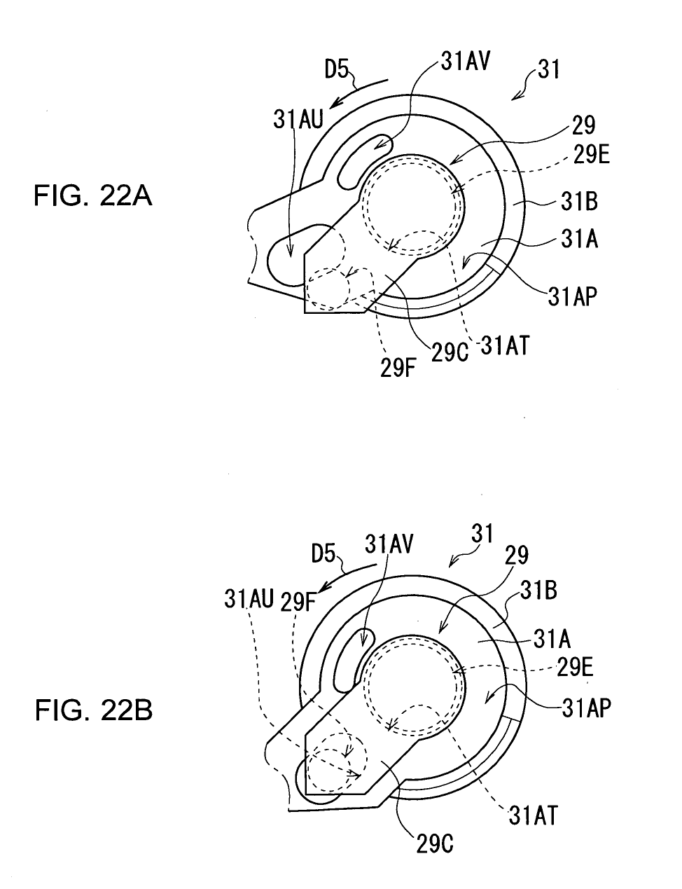

Accordingly, in such a case, as shown in FIG. 22A, the rotational body pinching units 30 and 31 are pushed to rotate the opening-and-closing unit 6 (or 7) in the closing direction D5, and the opening-and-closing unit 6 (or 7) rotate around the shaft supporting sections 30AT and 31AT, into which the shaft end sections 28E and 29E are engaged, in the closing direction D5.

In this manner, the rotational body pinching units 30 and 31 rotate in the closing direction D5. At the same time, the boundary pushes the angle reference units 28F and 29F to rotate the rotational body 26 until it reaches the closing direction limitation angle.

Since the rotational body 26 does not rotate anymore beyond the closing direction limitation angle, the facing surfaces 30AP and 31AP start to go up the angle reference units 28F and 29F.

As a result, as shown in FIG. 22B, the angle reference units 28F and 29F fit in the angle adjustment sections 30AU and 31AU.

After the shaft end sections 28E and 29E fit in the shaft supporting sections 30AT and 31AT, the edges of the tongue-shaped units 30AR and 31AR may be positioned apart from the angle reference units 28F and 29F.

In such a case, by pushing the opening-and-closing unit 6 (or 7) in the closing direction D5, the rotational body pinching units 30 and 31 rotate around the shaft supporting sections 30AT and 31AT, into which the shaft end sections 28E and 29E are engaged, in the closing direction D5.

Accordingly, the edges (or the boundary) of the tongue-shaped units 30AR and 31AR hit the sides of the angle reference units 28F and 29F, and the edges push the angle reference units 28F and 29F, and the rotational body 26 finally reaches the closing direction limitation angle.

Since the rotational body 26 does not rotate anymore beyond the closing direction limitation angle, the facing surfaces 30AP and 31Ap start to go up the angle reference units 28F and 29F.

As a result, the angle reference units 28F and 29F fit in the angle adjustment sections 30AU and 31AU.

Moreover, while the facing surfaces 30AP and 31AP are put on the shaft end sections 28E and 29E, they may go up the angle reference units 28F and 29F, depending on the distance between the tongue-shaped units 30AR and 31AR.

And, even if the shaft end sections 28E and 29E fit in the shaft supporting sections 30AT and 31AT, the facing surfaces 30AP and 31AP may be left on the angle reference units 28F and 29F i.e., the angle reference units 28F and 29F do not fit in the angle adjustment sections 30AU and 31AU.

In such a case, by pushing the opening-and-closing unit 6 (or 7) in the closing direction D5, the rotational body pinching units 30 and 31 rotate around the shaft supporting sections 30AT and 31AT, into which the shaft end sections 28E and 29E are engaged, in the closing direction D5.

As a result, the angle reference units 28F and 29F fit in the angle adjustment sections 30AU and 31AU.

In that manner, even if the pinching section direction is not aligned with the rotational body direction after the opening-and-closing unit 6 (or 7) is inserted in to the rotational body 26, by pushing the opening-and-closing unit 6 (or 7) in the closing direction D5, the rotational range of the rotational body 26 is aligned with the opening-and-closing range of the opening-and-closing unit 6 (or 7) with respect to the rotational unit 4 (or 5).

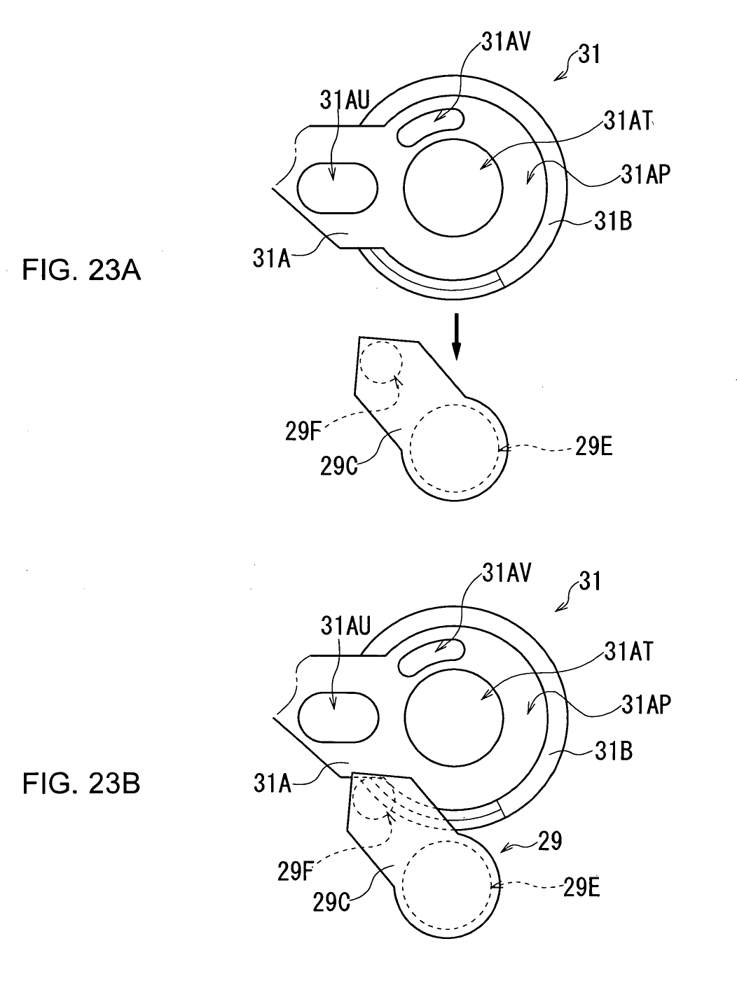

Furthermore, as shown in FIG. 23A, as for the opening-and-closing mechanical units 8 and 9, the pinching section direction may intersect with the rotational body direction when the opening-and-closing unit 6 (or 7) is attached to the rotational body 26: the opening-and-closing unit 6 (or 7) is held such that its inner central part faces the speaker 10 (or 11), and the rotational body 26 has been rotated in the opening direction D6.

In such a case, as shown in FIG. 23B, when the rotational body pinching units 30 and 31 are pushed toward the rotational unit holding section 25 so as to accept the rotational body 26 between the facing surfaces 30AP and 31AP, the edges (around the boundary) of the tongue-shaped units 30AR and 31AR hit the sides of the angle reference units 28F and 29F.

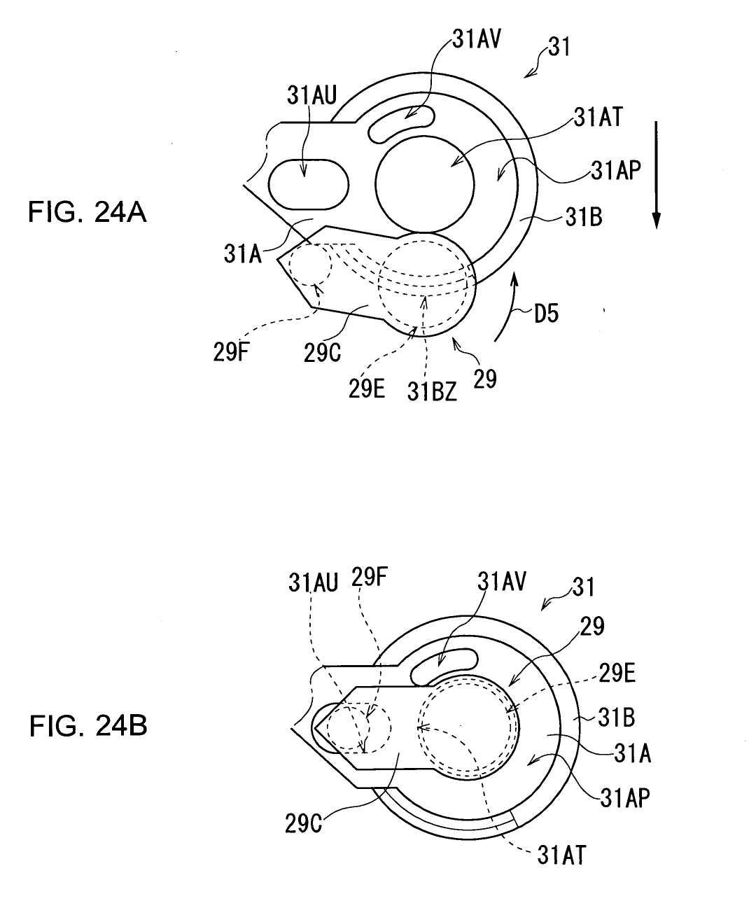

Subsequently, as shown in FIG. 24A, the edges (around the boundary) of the tongue-shaped units 30AR and 31AR push the sides of the angle reference units 28F and 29F to rotate the rotational body 26 in the closing direction D5.

And, as for the rotational body pinching units 30 and 31, the guidance cut-off sections 30BZ and 31BZ of the pinching direction guidance sections 30B and 31B are pushed toward the rotation central units 28A and 29A of the rotation conveying units 28 and 29, the facing surfaces 30AP and 31AP start to go up the shaft end sections 28E and 29E, since they are pushed toward the rotational unit holding section 25.

Since the facing surfaces 30AP and 31AP start to go up the shaft end sections 28E and 29E, the distance between the surfaces 30AP and 31AP (or between the tongue-shaped units 30AR and 31AR) widens. Accordingly, the facing surfaces 30AP and 31AP start to go up the angle reference units 28F and 29F.

Accordingly, as shown in FIG. 24B, the shaft end sections 28E and 29E finally fit in the shaft supporting sections 30AT and 31AT.

Moreover, the angle reference units 28F and 29F fit in the angle adjustment sections 30AU and 31AU.

In that manner, even if the pinching section direction intersects with the rotational body direction after the opening-and-closing unit 6 (or 7) is inserted into the rotational body 26, by pushing the opening-and-closing unit 6 (or 7) in the closing direction D5, the rotational range of the rotational body 26 is aligned with the opening-and-closing range of the opening-and-closing unit 6 (or 7) with respect to the rotational unit 4 (or 5).

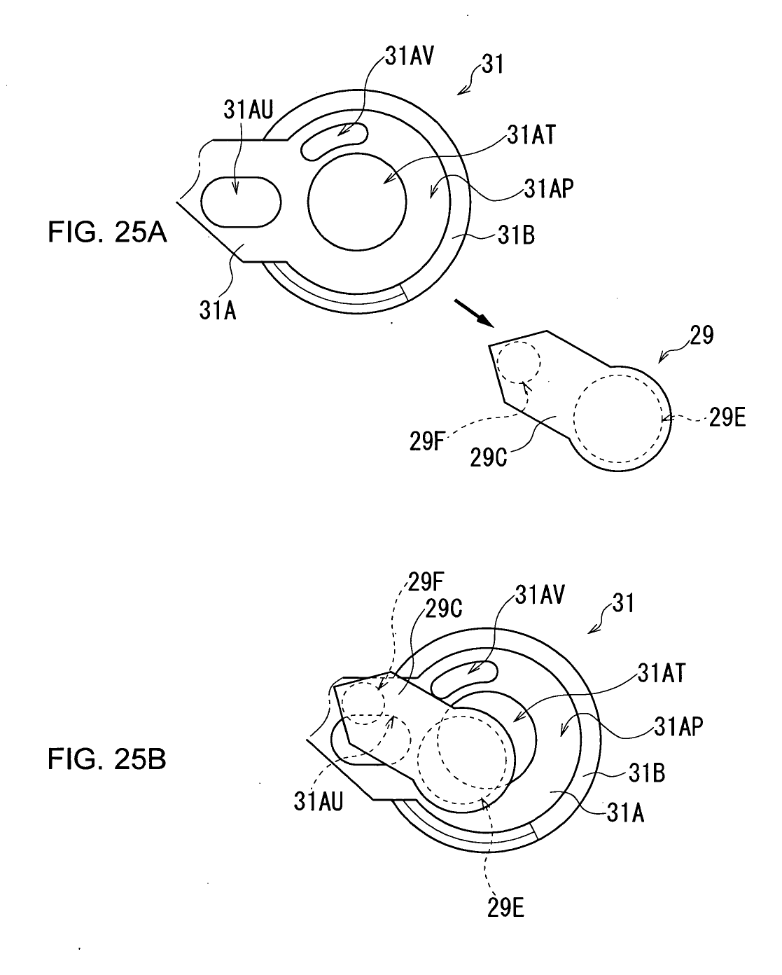

Furthermore, as shown in FIG. 25A, the rotational body pinching units 30 and 31 may be pushed from above the speaker 10 (or 11) toward the base of the rotational unit holding section 25 so as to gradually accept the rotational body 26 between the facing surfaces 30AP and 31AP, and therefore the pinching section direction intersects with the rotational body direction.

In this case, as shown in FIG. 25B, the rotation conveying units 28 and 29 diagonally pass through between the shaft supporting sections 30AT and 31AT and the angle adjustment sections 30AU and 31AU.

At this time, for example, as for the rotational body pinching units 30 and 31, the motion limitation section 30AV's portion which is close to the tongue-shaped unit 30AR, or the tongue-side portion, hit the edge 28BY of the rotation conveying unit 28.

Moreover, as for the rotational body pinching units 30 and 31, the motion limitation section 31AV's tongue-side portion also hit the edge 29BX of the rotation conveying unit 29.

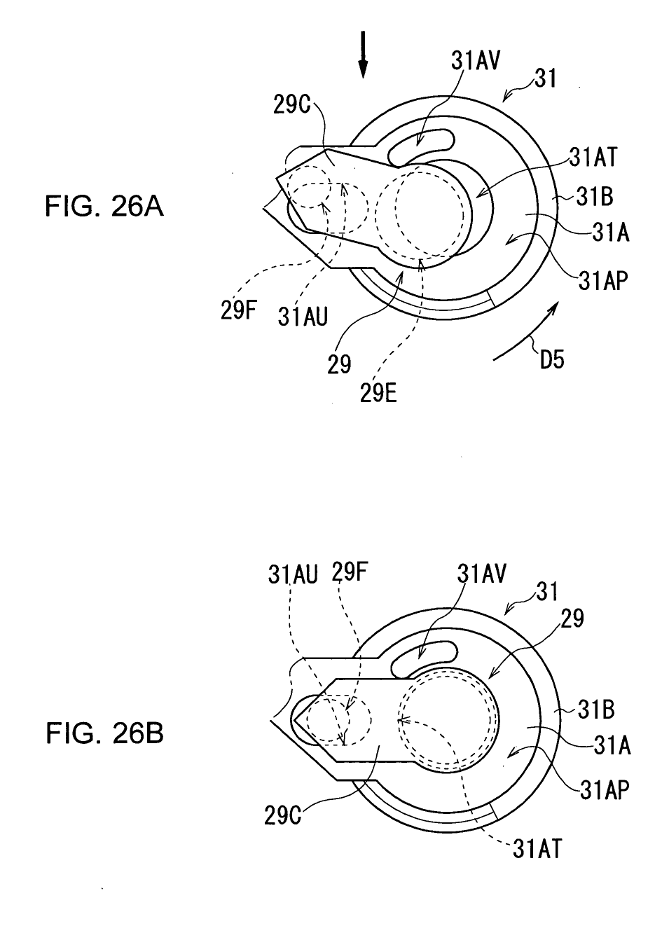

Subsequently, as shown in FIG. 26A, if the rotational body pinching units 30 and 31 are pushed from above the holding unit top surface 25C toward the base of the rotational unit holding section 25 so that the edge 4A (or 5A) of the rotational unit 4 (or 5) touches the edge 6A (or 7A) of opening-and-closing unit 6 (or 7), the tongue-side portions of the motion limitation sections 30AV and 31AV push the rotation conveying units 28 and 29 to rotate the rotational body 26 in the closing direction.

As a result, as shown in FIG. 26B, the shaft end sections 28E and 29E finally fit in the shaft supporting sections 30AT and 31AT.

Moreover, the angle reference units 28F and 29F fit in the angle adjustment sections 30AU and 31AU.

In that manner, even if the pinching section direction intersects with the rotational body direction after the opening-and-closing unit 6 (or 7) is diagonally inserted into the rotational body 26 such that the edge 4A (or 5A) of the rotational unit 4 (or 5) touches the edge 6A (or 7A) of opening-and-closing unit 6 (or 7), by pushing the opening-and-closing unit 6 (or 7) in the closing direction D5, the rotational range of the rotational body 26 is aligned with the opening-and-closing range of the opening-and-closing unit 6 (or 7) with respect to the rotational unit 4 (or 5).

By the way, if the rotational body pinching units 30 and 31 are pushed toward the rotational unit holding section 25 to attache the opening-and-closing unit 6 (or 7) to the rotational body 26, the facing surfaces 30AP and 31AP pass through the guidance cut-off sections 30BZ and 31BZ of pinching direction guidance sections 30B and 31B and go up the shaft end sections 28E and 29E and the angle reference units 28F and 29F.

Since the rotational body pinching units 30 and 31 are pushed toward the rotational unit holding section 25, the facing surfaces 30AP and 31AP slide on the top surfaces of the shaft end sections 28E and 29E and angle reference units 28F and 29F. As a result, the shaft end sections 28E and 29E and the angle reference units 28F and 29F are moved so that they are closer to the motion limitation sections 30AV and 31AV than to the guidance cut-off sections 30BZ and 31BZ.

Accordingly, the shaft end sections 28E and 29E fit in the shaft supporting sections 30AT and 31AT, and the angle reference units 28F and 29F fit in the angle adjustment sections 30AU and 31AU.

Here, as for the rotational body pinching units 30 and 31, when the opening-and-closing unit 6 (or 7) is attached to the rotational body 26, if the pinching section direction is aligned with the rotational body direction, with the rotation conveying units 28 and 29 parallel to each other, they are directly moved toward the motion limitation sections 30AV and 31AV with respect to the guidance cut-off sections 30BZ and 31BZ.

If the rotational body pinching units 30 and 31 are pushed forcefully toward the rotational unit holding section 25, it can be considered that the rotation conveying units 28 and 29 would overrun their appropriate positions. If this happens, the shaft end sections 28E and 29E may drop out from the shaft supporting sections 30AT and 31AT, and the angle reference units 28F and 29F from the angle adjustment sections 30AU and 31AU toward the motion limitation sections 30AV and 31AV.

However, the rotational body pinching units 30 and 31 prevent the rotation conveying units 28 and 29 from overrunning: the inside walls of the arc-shaped portions of the motion limitation sections 30AV and 31AV hit, for example, the sides of the rotation central units 28A and 29A and the sides 28BY and 29BX of the tongue-shaped units 28B and 29B.

In this manner, the rotational body pinching units 30 and 31 prevent the shaft end sections 28E and 29E and the angle reference units 28F and 29F from being separated from the shaft supporting sections 30AT and 31AT and the angle adjustment sections 30AU and 31AU, even if the rotational body pinching units 30 and 31 are forcefully pushed toward the rotational unit holding section 25.

On the other hand, as for the rotational body pinching units 30 and 31, when the opening-and-closing unit 6 (or 7) is attached to the rotational body 26, if the pinching section direction is not aligned with the rotational body direction, the rotation central units 28A and 29A of the rotation conveying units 28 and 29 are directly moved from the guidance cut-off sections 30BZ and 31BZ toward the motion limitation sections 30AV and 31AV.

At this time, the tongue-shaped units 28B and 29B of the rotation conveying units 28 and 29 are rotated around the rotation central units 28A and 29A, and they are moved from the guidance cut-off sections 30BZ and 31BZ toward the motion limitation sections 30AV and 31AV.

If the rotational body pinching units 30 and 31 are pushed forcefully, it can be considered that the rotation central units 28A and 29A of the rotation conveying units 28 and 29 would overrun the desirable positions toward the motion limitation sections 30AV and 31AV. In this case, the shaft end sections 28E and 29E may drop out from the shaft supporting sections 30AT and 31AT.

The rotational body pinching units 30 and 31, however, are designed to prevent the rotation conveying units 28 and 29 from overrunning: the inner wall of the motion limitation sections 30AV and 31AV hit the sides of the rotation central units 28A and 29A.

Accordingly, even if the rotational body pinching units 30 and 31 are pushed forcefully to engage the shaft end sections 28E and 29E in the shaft supporting sections 30AT and 31AT, the shaft end sections 28E and 29E do not drop out from the shaft supporting sections 30AT and 31AT.

If the rotational body pinching units 30 and 31 are pushed forcefully toward the rotational unit 4 (or 5), the tongue-shaped units 28B and 29B of the rotation conveying units 28 and 29 may rotate, and the rotation conveying units 28 and 29 may overrun. In this case, the angle reference units 28F and 29F may drop out from the angle adjustment sections 30AU and 31AU.

The rotational body pinching units 30 and 31, however, are designed to prevent the rotation conveying units 28 and 29 from overrunning: the inner wall of the motion limitation sections 30AV and 31AV hit the sides 28BY and 29BY of the tongue-shaped units 28B and 29B.

Accordingly, even if the rotational body pinching units 30 and 31 are pushed forcefully to engage the angle reference units 28F and 29F in the angle adjustment sections 30AU and 31AU, the angle reference units 28F and 29F do not drop out from the angle adjustment sections 30AU and 31AU.

Therefore, the shaft end sections 28E and 29E fit in the shaft supporting sections 30AT and 31AT, and the angle reference units 28F and 29F fit in the angle adjustment sections 30AU and 31AU. In this manner, the rotational body pinching units 30 and 31 firmly hold the rotational body 26.

After the rotational body pinching units 30 and 31 are pushed toward the rotational unit holding section 25, the facing surfaces 30AP and 31AP cover the outer surfaces 28D and 29D of the rotational body 26. In this manner, the opening-and-closing unit 6 (or 7) is attached to the rotational body 26.

The rotational body pinching units 30 and 31 are pushed toward the rotational unit holding section 25 when the opening-and-closing unit 6 (or 7) is attached to the rotational body 26. However, the opening-and-closing unit 6 (or 7) can be also attached to the rotational body 26 in the following manner: first, one of the facing surfaces 30AP and 31AP covers the outer surface 28D or 29D, and then the other facing surface covers the other outer surface.

In this case, first, one of the facing surfaces 30AP or 31AP covers one of the outer surfaces 28D or 29D such that the shaft end sections 28E and 29E fit in the shaft supporting sections 30AT and 31AT, and that the angle reference units 28F and 29F fit in the angle adjustment sections 30AU and 31AU. By doing this, the pinching section direction is aligned with the rotational body direction. Therefore, when the other facing surface 30AP or 31AP is attached to the outer surface 28D or 29D, their shaft end sections 28E and 29E can easily fit in the shaft supporting sections 30AT and 31AT. In addition, their angle reference units 28F and 29F can easily fit in the angle adjustment sections 30AU and 31AU.

Even if one of the facing surfaces 30AP or 31AP is attached to the outer surface 28D or 29D before the other facing surface 30AP or 31AP is appropriately attached to the outer surface 28D or 29D, by following the above attachment methods, their shaft end sections 28E and 29E and the angle reference units 28F and 29F can appropriately fit in the shaft supporting sections 30AT and 31AT and the angle adjustment sections 30AU and 31AU.

Furthermore, it is also possible that: one of the facing surfaces 30AP or 31AP covers one of the outer surfaces 28D or 29D such that the shaft end sections 28E and 29E fit in the shaft supporting sections 30AT and 31AT. And when the other facing surface 30AP or 31AP is attached to the outer surface 28D or 29D, the rest of the shaft end sections 28E and 29E and angle reference units 28F and 29F can be put in the shaft supporting sections 30AT and 31AT and the angle adjustment sections 30AU and 31AU.

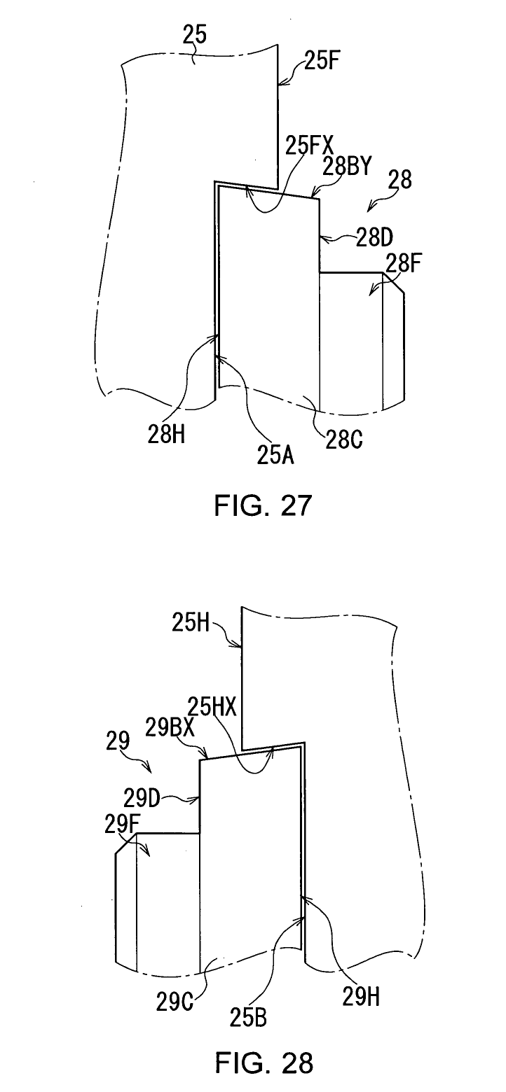

By the way, as shown in FIG. 27, there is a steep wall 25FX between the opening angle limitation section 25F and the one side surface 25A of the rotational unit holding section 25. The corner between the wall 25FX and the one side surface 25A cut into toward the holding unit back surface 25D.

That is, the opening angle limitation section 25F, the wall 25FZ, and the one side surface 25A are arranged in such a way that they form a shape of “Z”.

On the other hand, the side 28BY of the tongue-shaped unit 28 is inclined, with the broader surface 28H than the other surface (outer surface) 28D.

Accordingly, when the side 28BY of the rotation conveying unit 28 is pushed to the opening angle limitation section 25F, the side 28BY fit in between the wall 25FX and the one side surface 25A.

This prevents the rotation conveying unit 28 from overleaping the opening angle limitation section 25F toward the holding unit back surface 25D.

As shown in FIG. 28, there is a steep wall 25HX between the opening angle limitation section 25H and the other side surface 25B of the rotational unit holding section 25. The corner between the wall 25HX and the other side surface 25B cut into toward the holding unit back surface 25D.

That is, the opening angle limitation section 25H, the wall 25HX, and the other side surface 25B are arranged in such a way that they form a shape of “Z”.

On the other hand, the side 29BX of the tongue-shaped unit 29 is inclined, with the broader surface 29H than the other surface (outer surface) 29D.

Accordingly, when the side 29BX of the rotation conveying unit 29 is pushed to the opening angle limitation section 25H, the side 29BX fit in between the wall 25HX and the other side surface 25B.

This prevents the rotation conveying unit 29 from overleaping the opening angle limitation section 25H toward the holding unit back surface 25D.

In that manner, the opening angle limitation sections 25F and 25H limit the rotation of the rotational body 26 in the opening direction D6.

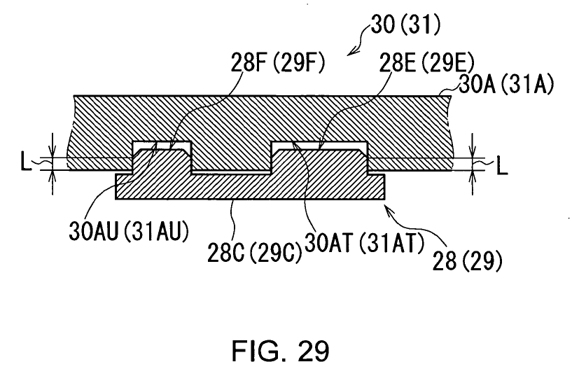

As shown in FIG. 29, as for the rotation conveying units 28 and 29, the height of the shaft end sections 28E and 29E is the same as the angle reference units 28F and 29F, but they are relatively low.

In addition, the edges of the shaft end sections 28E and 29E and the angle reference units 28F and 29F are chamfered.

Accordingly, the shaft end sections 28E and 29E and the angle reference units 28F and 29F are partly inserted into the shaft supporting sections 30AT and 31AT and the angle adjustment sections 30AU and 31AU. The portions inserted into that shaft supporting sections 30AT and 31AT and the angle adjustment sections 30AU and 31AU are also referred to as “inserted portions.”

Accordingly, the height L of the inserted portions is relatively small.

Therefore, if the rotation conveying units 28 and 29 already touching the opening angle limitation sections 25F and 25H are further pushed as the opening-and-closing unit 6 (or 7) is rotated in the opening direction D6, the shaft end sections 28E and 29E and the angle reference units 28F and 29F easily drop out from the shaft supporting sections 30AT and 31AT and the angle adjustment sections 30AU and 31AU.

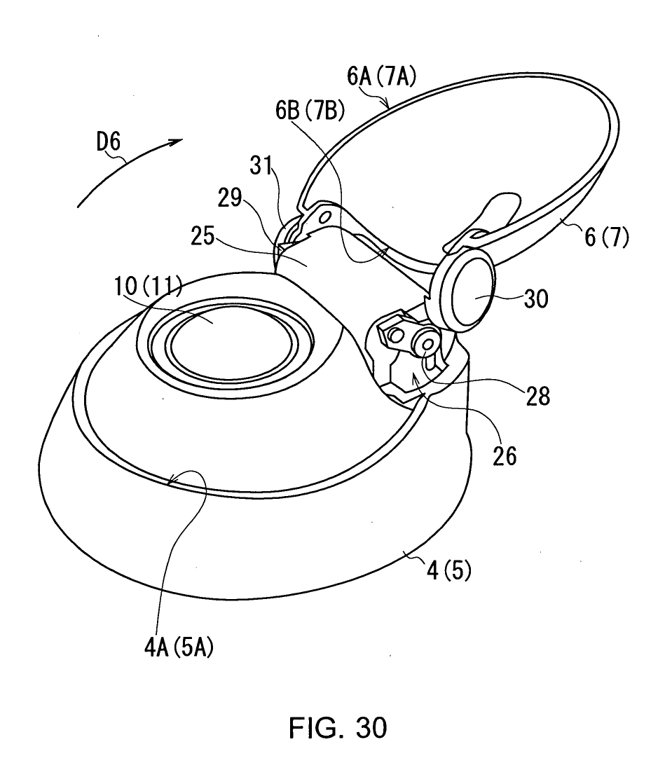

As shown in FIG. 30, if the fully opened opening-and-closing unit 6 (or 7) is unexpectedly hit by walls or tables, the rotational body pinching units 30 and 31 are forcefully rotated in the opening direction D6 beyond the opening angle range along with the rotational body 26.

However, the rotational body 26 may stop at the opening direction limitation angle after the rotation conveying units 28 and 29 hit the opening angle limitation sections 25F and 25H.

If the external force is continuously applied to the rotational body pinching units 30 and 31 even after the rotational body 26 is stopped by the opening angle limitation sections 25F and 25H, then the opening-and-closing unit 6 (or 7) rotates in the opening direction D6 toward the rotational unit holding section 25, and consequently the shaft end sections 28E and 29E and the angle reference units 28F and 29F drop out from the shaft supporting sections 30AT and 31AT and the angle adjustment sections 30AU and 31AU.

In that manner, even if the fully opened opening-and-closing unit 6 (or 7) is unexpectedly hit by walls or tables and the rotational body pinching units 30 and 31 are forcefully rotated in the opening direction D6 beyond the opening angle range, the opening-and-closing unit 6 (or 7) is detached from the rotational body 26, and thereby prevents itself and the rotational body pinching units 30 and 31 and the rotational body 26 from breakage.

After the opening-and-closing unit 6 (or 7) is detached from the rotational body 26, the opening-and-closing unit 6 (or 7) is easily attached to the rotational body 26 again.

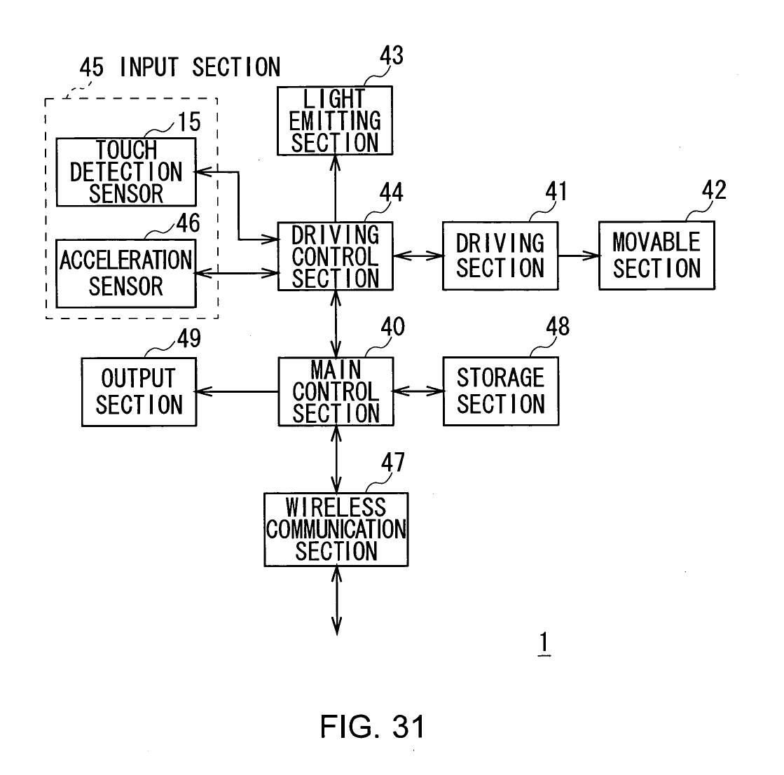

The following describes the circuit configuration of the audio robot device 1. As shown in FIG. 31, the audio robot device 1 includes a main control section 40 that takes overall control of the audio robot device 1.

The audio robot device 1 includes a driving section 41 that drives and controls a movable section 42. The audio robot device 1 also includes a driving control section 44 that controls a light emitting section 43.

In this case, the movable section 42 includes the right rotational unit 4, the left rotational unit 5, the right opening-and-closing unit 6, the left opening-and-closing unit 7, the right wheel 12, and the left wheel 13.

The light emitting section 43 includes the right light emitting unit 16, and the left light emitting unit 17.

The driving section 41 includes six motors each of which rotates one of the following components: the right rotational unit 4, the left rotational unit 5, the right opening-and-closing unit 6, the left opening-and-closing unit 7, the right wheel 12, and the left wheel 13.

The driving section 41 also includes six rotational detection sensors, such as rotary encoders, to detect the rotation of the six motors.

The driving control section 44 controls the motors of the driving section 41 based on robot-motion data generated from music data. As a result, the audio robot device 1 moves to the music.

In this manner, by controlling the motors of the driving section 41, the driving control section 44 drives the right rotational unit 4, the left rotational unit 5, the right opening-and-closing unit 6, the left opening-and-closing unit 7, the right wheel 12, and the left wheel 13.

The audio robot device 1 includes an input section 45. The input section 45 includes the touch detection sensor 15 and an acceleration sensor 46. The acceleration sensor 46 is placed inside the central unit 3 to detect acceleration of the ellipsoidal body 2.

When detecting a user's finger put on the sensor 15, the touch detection sensor 15 keeps supplying a touch detection signal to the driving control section 44.

The driving control section 44 receives the touch detection signal from the touch detection sensor 15, and thereby recognizes how the finger is put on the touch detection sensor 15.

That is, the driving control section 44, for example, recognizes a tap or two consecutive taps on the sensor 15, or the finger continuously put on the sensor 15.

The acceleration sensor 46, for example, detects the acceleration of the ellipsoidal body 2 around the clock: the detected acceleration is represented in three directions, or X, Y, and Z axes, which are perpendicular to one another.

The acceleration sensor 46 supplies the detected values of x-, y-, and z-acceleration to the driving control section 44 as an acceleration detection signal.

By the way, the x axis is parallel to or the same as the horizontal rotational shaft line L1 of the ellipsoidal body 2. The X axis is also parallel to the direction of a line connecting the left and right ends of the ellipsoidal body 2.

The z axis is parallel to the direction of a line connecting the upper and lower ends of the ellipsoidal body 2 taking the basic position.

The y axis is perpendicular to the horizontal rotational shaft line L1 and the direction of a line connecting the upper and lower ends of the ellipsoidal body 2 taking the basic position. In addition, the y axis is parallel to the direction of a line connecting the front and back ends of the ellipsoidal body 2 taking the basic position.

The driving control section 44, for example, has previously memorized in an internal memory an x-axis reference acceleration value, a y-axis reference acceleration value, and a z-axis reference acceleration value, which represent an x-axis acceleration, y-axis acceleration, and z-axis acceleration of the ellipsoidal body 2 staying on a horizontal floor.

The x-axis reference acceleration value, the y-axis reference acceleration value, and the z-axis reference acceleration value are also collectively referred to as reference acceleration values.

After receiving the acceleration detection signal from the acceleration sensor 46, the driving control section 44 recognizes the attitude of the ellipsoidal body 2 by comparing the acceleration detection signal and the reference acceleration values.

That is, the driving control section 44, for example, recognizes that the ellipsoidal body 2 stays on the floor, or that the ellipsoidal body 2 is running on the floor, or that the ellipsoidal body 2 in a user's hand is shaken.

After receiving the touch detection signal and the acceleration detection signal from the input section 45, the driving control section 44 makes a determination as to whether a command is input by a user into the audio robot device 1 by analyzing how the finger is put on the sensor 15 and the attitude of the ellipsoidal body 2.

If a command is input into the audio robot device 1, the driving control section 44 also decodes the command.

The driving control section 44 then supplies the decoded command to the main control section 40.

By the way, by touching the touch detection sensor 15 and changing the attitude of the ellipsoidal body 2, a user can input various commands into the audio robot device 1: a playback command of music, a selection command of selecting a piece of music, or the like.

The main control section 40 receives the commands from the drive control section 44, and controls every component of the audio robot device 1 to perform various processes.

The main control section 40 is able to wirelessly communicate with an information processing device (not shown), such as a personal computer, through a wireless communication section 47. In such a case, the main control section 40 is controlled by the information processing device.

If the information processing device transmits the compressed and encoded piece of music data and the corresponding robot motion data, the main control section 40 receives them through the wireless communication section 47.

The main control section 40 then stores the piece of music data and the corresponding robot motion data in the storage section 48 such that they are associated with one another.

In this manner, the main control section 40 can store the pieces of music data in the storage section 48 along with the corresponding robot motion data.

When a user inputs a playback command into the audio robot device 1 on the floor, the main control section 40 reads out the piece of music data from the storage section 48 and performs a playback process such as decoding. The main control section 40 then supplies the piece of music data to an output section 49 including the right and left speakers 10 and 11.

Therefore, the main control section 40 can output music from the right and left speakers 10 and 11.

At the same time (during the playback of music), the main control section 40 reads out the robot motion data, which corresponds to the piece of music, from the storage section 48, and supplies it to the driving control section 44.

The driving control section 44 controls the driving section.41 based on the robot motion data supplied from the main control section 40.

In this manner, the driving control section 44 controls the driving section 41 to drive the right rotational unit 4, the left rotational unit 5, the right opening-and-closing unit 6, the left opening-and-closing unit 7, the right wheel 12, and the left wheel 13.

In addition, the driving control section 44 controls the light emitting section 43, or right and left light emitting units 16 and 17, based on the robot motion data.

In that manner, while outputting music from the output section 49, the main control section 40 drives the movable section 42 and the light emitting section 43 in synchronization with the melody of music.

In this manner, the main control section 40 makes the audio robot device move as if dancing in synchronization with the music being played.

As mentioned above, the audio robot device 1 includes the rotation-side mechanical unit 20: the opening-and-closing mechanical units 8 and 9 are provided on the right and left opening-and-closing units 6 and 7 to allow the right and left opening-and-closing units 6 and 7 to open and close with respect to the right and left rotational units 4 and 5. The audio robot device 1 also includes the opening-and-closing-side mechanical unit 21 which is provided on the opening-and-closing unit 6 (or 7).

In the rotation-side mechanical unit 20 of the audio robot device 1, the shaft end sections 28E and 29E and the angle reference units 28F and 29F are provided on the outer surfaces 28D and 29D each of which faces outwardly and oppositely of the opposite surface along the rotational shaft 27 of the rotational body 26. The rotational unit holding section 25 holds the rotational body 26 in such a way that the rotational body 26 can rotate around the rotational shaft 27.

In the opening-and-closing-side mechanical unit 21 of the audio robot device 1, the shaft supporting sections 30AT and 31AT, which correspond to the shaft end sections 28E and 29E, and the angle adjustment sections 30AU and 31AU, which correspond to the angle reference units 28F and 29F, are provided on the facing surfaces 30AP and 31AP of the rotational body pinching units 30 and 31 attached to the opening-and-closing unit 6 (or 7).

When the opening-and-closing unit 6 (or 7) is pushed toward the rotational unit 4 (or 5) as if making them close such that the facing surfaces 30AP and 31AP of the rotational body pinching units 30 and 31 cover the outer surfaces 28D and 29D of the rotational body 26, the shaft supporting sections 30AT and 31AT and angle adjustment sections 30AU and 31AU of the rotational body pinching units 30 and 31 fit in the shaft end sections 28E and 29E and angle reference units 28F and 29F of the rotational body 26. In this manner, the rotational body 26 is held by the rotational body pinching units 30 and 31.

Therefore, without checking and adjusting the angle of the rotational body 26, a user can insert the rotational body 26 into the opening-and-closing unit 6 (or 7) in such a way that the rotational range of the rotational body 26 is appropriately aligned with the opening-and-closing range of the opening-and-closing unit 6 (or 7) with respect to the rotational unit 4 (or 5).

According to the above configuration, when the opening-and-closing unit 6 (or 7) is pushed toward the rotational unit 4 (or 5) as if making them close such that the facing surfaces 30AP and 31AP of the rotational body pinching units 30 and 31 cover the outer surfaces 28D and 29D of the rotational body 26, the shaft supporting sections 30AT and 31AT and angle adjustment sections 30AU and 31AU of the rotational body pinching units 30 and 31 fit in the shaft end sections 28E and 29E and angle reference units 28F and 29F of the rotational body 26. In this manner, the rotational body 26 is held by the rotational body pinching units 30 and 31.

Therefore, without checking and adjusting the angle of the rotational body 26, a user can insert the rotational body 26 into the opening-and-closing unit 6 (or 7) in such a way that the rotational range of the rotational body 26 is appropriately aligned with the opening-and-closing range of the opening-and-closing unit 6 (or 7) with respect to the rotational unit 4 (or 5).

Thus, the opening-and-closing unit 6 (or 7) can be easily attached to the rotational body 26.

Moreover, as for the rotational body pinching units 30 and 31, the outer wall edge sections 30BY and 31BY, except the portions near the edge 6A (or 7A) of the opening-and-closing unit 6 (or 7), protrude from the facing surfaces 30AP and 31AP to form the pinching direction guidance sections 30B and 31B; and the pinching direction guidance sections 30B and 31B have the guidance cut-off sections 30BZ and 31BZ, generated by being cut off to the level of the facing surfaces 30AP and 31AP, to guide the insertion direction of the rotational body 26.

Accordingly, even if the opening-and-closing unit 6 (or 7) is mistakenly inserted and pushed toward the rotational unit holding section 25 in such a way that the outer surface of the opening-and-closing unit 6 (or 7) faces the diaphragm of the speaker 10 (or 11), the facing surfaces 30AP and 31AP of the rotational body pinching units 30 and 31 do not go up the shaft end sections 28E and 29E and the angle reference units 28F and 29F.

This prevents the outer surface of the opening-and-closing unit 6 (or 7) from damaging the diaphragm of the speaker 10 (or 11).

Moreover, on the facing surfaces 30AP and 31AP of the rotational body pinching units 30 and 31, the motion limitation sections 30AV and 31AV are provided on the opposite side to the guidance cut-off sections 30BZ and 31BZ with respect to the shaft supporting sections 30AT and 31AT and the angle adjustment sections 30AU and 31AU.

Accordingly, when the rotational body 26 is being inserted into between the rotational body pinching units 30 and 31, and when the shaft end sections 28E and 29E and the angle reference units 28F and 29F slide on the facing surfaces 30AP and 31AP from the guidance cut-off sections 30BZ and 31BZ toward the shaft supporting sections 30AT and 31AT and the angle adjustment sections 30AU and 31AU, the motion limitation sections 30AV and 31AV limit this movement. This makes sure that the shaft end sections 28E and 29E and the angle reference units 28F and 29F fit in the shaft supporting sections 30AT and 31AT and the angle adjustment sections 30AU and 31AU.

Furthermore, the height of the inserted portions of the shaft end sections 28E and 29E and the angle reference units 28F and 29F are properly selected. Therefore, if the rotation conveying units 28 and 29 already touching the opening angle limitation sections 25F and 25H are further pushed as the opening-and-closing unit 6 (or 7) is rotated in the opening direction D6, the shaft end sections 28E and 29E and the angle reference units 28F and 29F easily drop out from the shaft supporting sections 30AT and 31AT and the angle adjustment sections 30AU and 31AU.

Accordingly, if the fully opened opening-and-closing unit 6 (or 7) is unexpectedly hit by walls or tables, the rotational body pinching units 30 and 31 are forcefully rotated in the opening direction D6 beyond the opening angle range along with the rotational body 26. However, the rotational body 26 may stop at the opening direction limitation angle after the rotation conveying units 28 and 29 hit the opening angle limitation sections 25F and 25H. If the external force is continuously applied to the rotational body pinching units 30 and 31 even after the rotational body 26 is stopped by the opening angle limitation sections 25F and 25H, then the opening-and-closing unit 6 (or 7) rotates in the opening direction D6 toward the rotational unit holding section 25, and consequently the shaft end sections 28E and 29E and the angle reference units 28F and 29F drop out from the shaft supporting sections 30AT and 31AT and the angle adjustment sections 30AU and 31AU.

In that manner, even if the fully opened opening-and-closing unit 6 (or 7) is unexpectedly hit by walls or tables and the rotational body pinching units 30 and 31 are forcefully rotated in the opening direction D6 beyond the opening angle range, the opening-and-closing unit 6 (or 7) is detached from the rotational body 26, and thereby prevents itself and the rotational body pinching units 30 and 31 and the rotational body 26 from breakage.

In the above-noted embodiment, on the rotation conveying units 28 and 29, the circular convex shaft end sections 28E and 29E and the circular convex angle reference units 28F and 29F are provided; on the rotational body pinching units 30 and 31, the circular concave shaft supporting sections 30AT and 31AT and the oval-track-shaped concave angle adjustment sections 30AU and 31AU are provided. However the present invention is not limited to this. The following is acceptable: on the rotation conveying units 28 and 29, the circular concave shaft end sections 28E and 29E and the oval-track-shaped concave angle reference units 28F and 29F are provided; on the rotational body pinching units 30 and 31, the circular convex shaft supporting sections 30AT and 31AT and the circular convex angle adjustment sections 30AU and 31AU are provided.

The following is also acceptable: on the rotation conveying units 28 and 29, the circular convex shaft end sections 28E and 29E and the oval-track-shaped concave angle reference units 28F and 29F are provided; on the rotational body pinching units 30 and 31, the circular concave shaft supporting sections 30AT and 31AT and the circular convex angle adjustment sections 30AU and 31AU are provided.

Furthermore, the following is also acceptable: on the rotation conveying units 28 and 29, the circular concave shaft end sections 28E and 29E and the circular convex angle reference units 28F and 29F are provided; on the rotational body pinching units 30 and 31, the circular convex shaft supporting sections 30AT and 31AT and the oval-track-shaped concave adjustment sections 30AU and 31AU are provided.

Moreover, in the above-noted embodiment, on the rotation conveying units 28 and 29, the circular convex angle reference units 28F and 29F are provided. However the present invention is not limited to this. The concave or convex circular convex angle reference units 28F and 29F may have a different shape.

Furthermore, in the above-noted embodiment, on the rotational body pinching units 30 and 31, the oval-track-shaped concave angle adjustment sections 30AU and 31AU are provided. However, the present invention is not limited to this. The concave angle adjustment sections 30AU and 31AU may have a different shape.

Furthermore, in the above-noted embodiment, the rotation conveying units 28 and 29 have the angle reference units 28F and 29F; the rotational body pinching units 30 and 31 have the angle adjustment sections 30AU and 31AU. However the present invention is not limited to this. Only one of the rotation conveying units 28 and 29 may have the angle reference unit 28F or 29F; only one of the rotational body pinching units 30 and 31 may have the angle adjustment section 30AU or 31AU.

Furthermore, in the above-noted embodiment, the opening-and-closing mechanical units 8 and 9 of the audio robot device 1 (FIGS. 1 to 31) are applied as an opening-and-closing device according to an embodiment of the present invention. However, the present invention is not limited to this. The above configuration can be applied not only to the opening-and-closing mechanical units 8 and 9, but also to the opening-and-closing mechanisms of information processing devices (like computers, cell phones, Personal Digital Assistance), recording and reproduction devices for optical discs, maintenance machines, speaker units or the like.

Furthermore, in the above-noted embodiment, the audio robot device 1 (FIGS. 1 to 31) is applied to as a robot device. However the present invention is not limited to this. It may also be applied to various robots, including robots walking with two or four legs in synchronization with music or sound.

Furthermore, in the above-noted embodiment, the right and left rotational units 4 and 5 (FIGS. 1 to 31) are applied to as a base unit. However the present invention is not limited to this. It may also be applied to various base units, including a base unit exposing the front diaphragm of a speaker, a housing section attached to the right and left ends of the central unit 3, a speaker unit's housing section housing a speaker, a box not housing a speaker.

Furthermore, in the above-noted embodiment, the right and left opening-and-closing units 6 and 7 (FIGS. 1 to 31) are applied to as an opening-and-closing unit. However the present invention is not limited to this. It may also be applied to various opening-and-closing units, including a flat opening-and-closing unit, a substantially dome-shaped opening-and-closing unit which exposes the front diaphragm of a speaker and is attached to the right and left rotational units such that they can rotate.

Furthermore, in the above-noted embodiment, the rotational body 26 including the rotational shaft 27 and the rotation conveying units 28 and 29 (FIGS. 1 to 31) is applied to as a rotational body with two outer surfaces facing outwardly and oppositely of the opposite surface, both of which are equipped with the shaft end sections which are the equivalent of the one and other ends of the rotational shaft, and at least one of which is equipped with an angle reference section that aligns the rotational range around the rotational shaft with the opening-and-closing range of an opening-and-closing unit with respect to the base unit. However the present invention is not limited to this. It may also be applied to various rotational bodies, including a rotational body generated by putting the rotational shaft 27 and the rotation conveying units 28 and 29 together in one unit.

Furthermore, in the above-noted embodiment, the rotational unit holding section 25 (FIGS. 1 to 31) is applied to as a rotational body holding unit provided on the base unit, the rotational body holding unit holding the rotational body such that the opening-and-closing unit can rotate around the rotational shaft in closing and opening directions to be closed and opened with respect to the base unit within a predetermined rotational angle range. However the present invention is not limited to this. It may also be applied to various rotational unit holding units, such as a rotational unit holding unit not equipped with a motor (therefore rotated by a hand).

Furthermore, in the above-noted embodiment, the rotational body pinching units 30 and 31 (FIGS. 1 to 31) are applied to as a pair of rotational body pinching units with facing surfaces by which the outer surfaces of the rotational body are covered and held, the facing surfaces being equipped with shaft supporting sections corresponding to the shaft end sections and angle adjustment sections in which the angle reference sections fit to align the rotational range with the opening-and-closing range. However the present invention is not limited to this. It may also be applied to various rotational body pinching units, including a rotational body pinching unit created by putting the pinching main bodies 30A and 31A and the pinching direction guidance sections 30B and 31B together in one unit.

Furthermore, in the above-noted embodiment, the pinching direction guidance sections 30B and 31B (FIGS. 1 to 31) are applied to as a direction guidance section that guides the direction of the rotational body whose outer surfaces are covered by the facing surfaces and slide on the facing surfaces when the rotational body is attached to the opening-and-closing unit. However the present invention is not limited to this. It may also be applied to various guidance sections.

Furthermore, in the above-noted embodiment, the motion limitation sections 30AV and 31AV (FIGS. 1 to 31) are applied to as a motion limitation unit that limit the motion of the outer surfaces of the rotational body with respect to the facing surfaces so that the shaft end sections fit in the shaft supporting sections and that the angle reference sections fit in the angle adjustment sections with the facing surfaces covering the outer surfaces of the rotational body. However the present invention is not limited to this. It may also be applied to various motion limitation sections.

The above method can be applied to opening-and-closing devices and robot devices, including an audio robot device including an opening-and-closing section that opens and closes with respect to a rotational section housing a speaker.

It should be understood by those skilled in the art that various modifications, combinations, sub-combinations and alterations may occur depending on design requirements and other factors insofar as they are within the scope of the appended claims or the equivalents thereof.

1. An opening-and-closing device whose opening-and-closing unit can open and close with respect to a base unit, comprising:
a rotational body with two outer surfaces both facing outwardly and oppositely of the other surface, both of which are equipped with shaft end sections that are the equivalent of the one and other ends of a rotational shaft at the ends of which the outer two surfaces are provided, and at least one of which is equipped with an angle reference section that aligns a rotational range around the rotational shaft with an opening-and-closing range of the opening-and-closing unit wit respect to the base unit;
a rotational body holding unit provided on the base unit, the rotational body holding unit holding the rotational body such that the opening-and-closing unit can rotate around the rotational shaft in closing and opening directions to be closed and opened with respect to the base unit within a predetermined rotational angle range; and
a pair of rotational body pinching units with facing surfaces by which the outer surfaces of the rotational body are covered and held, the facing surfaces being equipped with shaft supporting sections corresponding to the shaft end sections, and at least one of the facing surfaces being equipped with an angle adjustment section in which the angle reference section fits to align the rotational range with the opening-and-closing range, wherein
when the opening-and-closing unit is pushed toward the base unit as if making them close such that the facing surfaces of the rotational body pinching units cover the outer surfaces of the rotational body to attach the opening-and-closing unit to the rotational body, the shaft end sections and the angle reference section fit in the shaft supporting sections and the angle adjustment section respectively, and thereby hold the rotational body so as to align the rotational range with the opening-and-closing range.

2. The opening-and-closing device according to claim 1, wherein
when the opening-and-closing unit is pushed toward the base unit as if making them close such that the facing surfaces of the rotational body pinching units cover the outer surfaces of the rotational body to attach the opening-and-closing unit to the rotational body, the shaft end sections fit in the shaft supporting sections, and then the angle adjustment section fits in the angle reference section after rotating in the closing direction around the shaft supporting sections, and thereby hold the rotational body so as to align the rotational range with the opening-and-closing range.

3. The opening-and-closing device according to claim 2, wherein
the rotational body pinching units include a direction guidance unit that guides a direction of the rotational body whose outer surfaces are covered by the facing surfaces and slide on the facing surfaces when the rotational body is attached to the opening-and-closing unit.

4. The opening-and-closing device according to claim 3, wherein
the rotational body pinching units include a motion limitation unit that limit motion of the outer surfaces of the rotational body with respect to the facing surfaces so that the shaft end sections fit in the shaft supporting sections and that the angle reference section fits in the angle adjustment section with the facing surfaces covering the outer surfaces of the rotational body.

5. The opening-and-closing device according to claim 4, wherein
one of the shaft end sections and the shaft supporting sections are convex and the other are concave, and one of the angle reference section and the angle adjustment section is convex and the other is concave; and
the height of the convex section's portion inserted in the concave section is selected so that, when the rotational body to which the opening-and-closing unit is attached is rotated in the opening direction beyond the rotational angle range, the convex section can drop out from the concave section.

6. A robot device comprising:
a base unit;
an opening-and-closing unit that opens and closes with respect to the base unit;
a rotational body with two outer surfaces both facing outwardly and oppositely of the other surface, both of which are equipped with shaft end sections that are the equivalent of the one and other ends of a rotational shaft at the ends of which the outer two surfaces are provided, and at least one of which is equipped with an angle reference section that aligns a rotational range around the rotational shaft with the an opening-and-closing range of the opening-and-closing unit with respect to the base unit;
a rotational body holding unit provided on the base unit, the rotational body holding unit holding the rotational body such that the opening-and-closing unit can rotate around the rotational shaft in closing and opening directions to be closed and opened with respect to the base unit within a predetermined rotational angle range;
a driving unit that rotates the rotational body round the rotational shaft;
a pair of rotational body pinching units with facing surfaces by which the outer surfaces of the rotational body are covered and held, the facing surfaces being equipped with shaft supporting sections corresponding to the shaft end sections, and at least one of the facing surfaces being equipped with an angle adjustment section in which the angle reference section fits to align the rotational range with the opening-and-closing range, wherein
when the opening-and-closing unit is pushed toward the base unit as if making them close such that the facing surfaces of the rotational body pinching units cover the outer surfaces of the rotational body to attach the opening-and-closing unit to the rotational body, the shaft end sections and the angle reference section fit in the shaft supporting sections and the angle adjustment section respectively, and thereby hold the rotational body so as to align the rotational range with the opening-and-closing range.
